(19) United States
(12) Patent Application Publication
(10) Pub. No.: US 2009/0200509 A1
(43) Pub. Date: Aug. 13, 2009

(54) ACTIVE MATERIAL, ELECTRODE, AND METHODS OF MANUFACTURE THEREOF

(75) Inventors: Hisashi SUZUKI, Tokyo (JP); Tadashi SUZUKI, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/204,340

(22) Filed: Sep. 4, 2008

(30) Foreign Application Priority Data
Feb. 13, 2008 (JP) 2008-032321
Jun. 16, 2008 (JP) 2008-157147

(51) Int. Cl. H01M 4/36; B05D 7/00; B05D 5/12

(52) U.S. Cl. 252/182.1; 427/215; 427/77; 429/218.1

(57) ABSTRACT

An active material having a good cycle performance is produced by bringing a metal-fluoro complex-containing aqueous solution into contact with particles of a first metal oxide so as to form, on surfaces of the first metal oxide particles, particles of a second metal oxide that is an oxide of the metal in the metal-fluoro complex. The active material is composed of particles of the first metal oxide and particles of the second metal oxide which coat the first metal oxide particles and have an average diameter of 50 nm or less. The second metal oxide particles have an adhesive force to the first metal oxide particles of at least 0.1 μN.

### BACKGROUND OF THE INVENTION

1. Field of the Invention

The present invention relates to methods of manufacturing active materials and electrodes for use in rechargeable electrochemical devices such as lithium ion secondary batteries and electric double-layer capacitors. The invention also relates to active materials and electrodes manufactured by such methods.

2. Related Background Art

Rechargeable electrochemical devices such as lithium ion secondary batteries and electric double-layer capacitors (EDLC) are widely used in consumer electronics such as cellular phones, notebook computers, personal digital assistants (PDA). Positive electrode active materials used in lithium ion secondary batteries include primarily LiCoO₂, LiNiₓCo₁₋ₓO₂, LiMn₂O₄, LiCoₓNi_{y}Mn_{1-x-y}O₂ and LiCoₓNi_{y}Al_{1-x-y}O₂. Negative electrode active materials that have been used or studied are primarily carbonaceous materials such as synthetic graphite, natural graphite, mesocarbon microbeads (MCMB), coke and fibrous carbon. Batteries in which these positive electrode active materials and negative electrode active materials are combined have a cutoff voltage during charging of 4.1 to 4.2 V and an energy density of as much as 400 to 500 Wh/L.

Recently, with the growth in energy consumption by equipment, there exists a strong desire for even higher energy densities in batteries. However, achieving further increases in energy density by optimizing battery design (such as making the housing that holds the battery components thinner, and reducing the thicknesses of the current collectors for the positive and negative electrodes and of the separator) has become quite difficult.

One method for increasing the energy density is to utilize, in the positive electrode active material, the additional capacity afforded by a higher potential than is typically employed in charging and discharging; in other words, to increase the energy density by raising the battery charging voltage. By raising the discharge voltage (to 4.6 V vs. Li/Li⁺) relative to the conventional charging voltage (4.2 V to 4.3 V vs. Li/Li⁺), LiCoₓNi_{y}Mn_{1-x-y}O₂ is able to increase the discharge capacity, enabling a higher energy density to be achieved.

However, increasing the charging voltage gives rise to new problems, such as a decrease in the cycle life and storage characteristics of the battery (owing to decomposition of the electrolyte solution, electrolyte, and positive electrode active material), and a decline in the thermal stability of the battery (due to the lower exothermic peak temperature of the positive electrode active material or an increase in the amount of heat generated). Solutions that have been proposed to avoid these problems include coating the surface of the positive electrode active material with an oxide.

Japanese Patent Application Laid-open No. H07-288127 discloses a nonaqueous electrolyte cell composed of a positive electrode active material, a negative electrode active material and a nonaqueous electrolyte, wherein an oxide differing from the positive electrode active material and the negative electrode active material is included in a surface layer on the particles making up at least one of the active materials, and the surface layer on the active material particles contains from 0.1 to 10 wt % of the oxide based on the active material. This oxide, which is described as being an oxide having a chemical formula different from the positive electrode active material and the negative electrode active material, is exemplified by PbO₂, Fe₂O₃, SnO₂, In₂O₃ and ZnO. In addition, a method for including the oxide in the surface layer on the active material particles which involves forming a hydroxide of the target element on the surface of the active material particles, then converting the hydroxide to an oxide by the application of heat is also disclosed.

Japanese Patent Application Laid-open No. H04-319260 (Japanese Patent No. 2855877) discloses a nonaqueous electrolyte secondary battery composed of a positive electrode made of the compound Li₁₋ₓCoO₂ (0≦x<1) to which zirconium (Zr) has been added, or wherein some portion of the cobalt has been substituted with another transition metal; a negative electrode made of lithium, a lithium alloy or a carbonaceous material; and a nonaqueous electrolyte solution. This disclosure also mentions that by adding zirconium to a mixture of a lithium salt with a cobalt compound and firing, the surfaces of LiCoO₂ particles are covered with zirconium oxide ZrO₂ or the double oxide Li₂ZrO₃ of lithium and zirconium and thereby stabilized. In addition, Japanese Patent Application Laid-open No. H04-319260 (Japanese Patent No. 2855877) states the following in paragraph: “This effect is not achievable by merely mixing zirconium or a zirconium compound with fired LiCoO₂, but can be achieved by adding zirconium to a mixture of a lithium salt and a cobalt compound, then firing.”

Japanese Patent Application Laid-open No. 2005-85635 discloses a nonaqueous electrolyte secondary battery which is charged at an end-of-charge voltage of at least 4.3 V and has a positive electrode containing lithium cobaltate as the positive electrode active material, a negative electrode containing a graphite material, and a nonaqueous electrolyte solution containing ethylene carbonate as the solvent. The lithium cobaltate has a zirconium-containing compound deposited on the particle surfaces thereof. The positive electrode active material is obtained by firing a mixture of a lithium salt, tricobalt tetraoxide (Co₃O₄) and a zirconium compound.

Japanese Patent Application Laid-open No. 2000-200605 discloses a nonaqueous electrolyte battery composed of a battery case filled with a positive electrode having a positive electrode active material composed primarily of lithium cobaltate, a negative electrode, and an electrolyte which contains a nonaqueous solvent. The positive electrode active material is a composite of LiCoO₂ and titanium obtained by depositing titanium particles and/or titanium compound particles onto the surface of lithium cobaltate particles. Here, a titanium oxide powder and/or a metallic lithium powder is mixed with a lithium cobaltate powder and fired, thereby producing a lithium cobaltate-titanium composite in which titanium oxide particles and/or metallic titanium particles have been deposited onto the surfaces of lithium cobaltate particles.

Japanese Patent Application Laid-open No. 2006-107763 discloses a method for obtaining an active material by bringing an aqueous solution containing an iron-fluoro complex and boric acid into contact with a carbon powder so as to form iron oxyhydroxide on the carbon powder. Also disclosed is a method in which an aqueous solution containing an iron-fluoro complex and boric acid is brought into contact with a current collector, thereby forming iron oxyhydroxide on the current collector.

Japanese Patent Application Laid-open No. 2005-276454 describes a method of preparing a positive electrode active material for lithium ion secondary batteries which involves spraying an aqueous alumina sol dispersion onto a lithium-cobalt double oxide powder formed into a fluidized layer by blowing with heated air, then drying at 400 to 650° C. so as to form from 1.0 to 8.0 parts by weight of an amorphous alumina coat on 100 parts by weight of the lithium-cobalt double oxide powder.

Electrochemical and Solid-State Letters 6 (11), A221-A224(2003) and Electrochimica Acta 49, 1079-1090 (2004) disclose Al₂O₃, ZrO₂ and SiO₂-coated LiCoO₂ obtained by adding LiCoO₂ to various coating solutions. The ZrO₂ in the coat is described as being composed of particles having a diameter of 10 nm and as having an irregular surface and being porous.

Electrochemical and Solid-State Letters 6 (1), A16-A18 (2003) discloses a process for coating LiCoO₂ using coating solutions of aluminum nitrate, titanium propoxide or zirconium propoxide. LiCoO₂ is dispersed in the respective solutions, then heat-treated at 300° C. to form an oxide coat. Production is carried out so as to set the oxide concentration to 3 parts by weight. Al₂O₃ and ZrO₂ are described as being composed of loose flakes or clusters of flakes, and adhering irregularly to the surface of the LiCoO₂.

### SUMMARY OF THE INVENTION

However, in prior-art active materials, a sufficient cycle performance is not achieved, although it is impossible to definitively attribute the cause to the formation of a high-resistance film owing to decomposition of the electrolyte solution at the surface of the positive electrode active material. The deterioration in the charge-discharge cycle performance is especially pronounced when the battery is charged at a high voltage. Moreover, there exists a desire for active materials having an improved charge-discharge cycle performance, even when charging is not carried out at a high voltage.

It is therefore an object of the present invention to provide an active material which has a good charge-discharge cycle performance. Another object of the invention is to provide an electrode which has a good charge-discharge cycle performance. Further objects of the invention are to provide production methods of such an active material and electrode.

The inventors have found that by using a specific method to coat the surface of particles of a metal oxide serving as the active material (referred to below as the “first metal oxide”) with particles of another metal oxide (referred to below as the “second metal oxide”), the charge-discharge cycle performance can be improved relative to the prior art. This method entails dipping particles of the first metal oxide in an aqueous solution of a metal-fluoro complex, and optionally adding a chemical substance called a scavenger so as to shift the equilibrium of the chemical formula (1) below to the right. This method is called “liquid-phase deposition.”

MFₓ^{(x-2n)}+nH₂O=MOₙ+xF⁻+2nH⁺ (1)

H₃BO₃+4H⁺+4F⁻=HBF₄+3H₂O (2)

Al+6H⁺+6F⁻=H₃AlF₆+ 3/2H₂ (3)

Boric acid (H₃BO₃), aluminum (Al) and the like may be used as the scavenger. Boric acid reacts with fluoride ions as shown in formula (2) to form HBF₄. When fluoride ions are consumed, the equilibrium in formula (1) moves to the right, promoting the formation of MOₙ as the second metal oxide. Similarly, aluminum reacts with fluoride ions as shown in formula (3) to form H₃AlF₆. As a result, the equilibrium in formula (1) shifts in the direction of MOₙ formation as the second metal oxide.

Examples of the starting materials and the product (oxide) when particles of the second metal oxide are produced by this liquid-phase deposition process are shown in Table 1.

TABLE 1

| | |
|---|---|
| PRODUCT | STARTING MATERIALS |

| | | | |
|---|---|---|---|
| ZrO₂ | H₂ZrF₆ | K₂ZrF₆ | (NH₄)₂ZrF₆ |
| SiO₂ | H₂SiF₆ | K₂SiF₆ | (NH₄)₂SiF₆ |
| TiO₂ | H₂TiF₆ | K₂TiF₆ | (NH₄)₂TiF₆ |
| ZnO | ZnF₂ | | |
| In₂O₃ | InF₃ | | |
| SnO | SnF₂ | | |
| SnO₂ | SnF₄ | SnF₂ | |
| MgO | MgF₂ | | |
| Al₂O₃ | AlF₃ | | |

By using the liquid-phase deposition process, particles of a second metal oxide (e.g., ZrO₂, TiO₂, SiO₂, ZnO, In₂O₃, SnO₂, MgO, Al₂O₃) which are dense, have a good crystallinity and adhere well to the active material can be coated onto the surface of a substance, even when the substance has an irregular surface as in the case of the active material particles.

The inventive production method of an active material includes the step of bringing a metal-fluoro complex-containing aqueous solution into contact with particles of a first metal oxide so as to form, on surfaces of the first metal oxide particles, particles of a second metal oxide that is an oxide of the metal in the metal-fluoro complex.

The inventive production method of an electrode includes the step of bringing a metal-fluoro complex-containing aqueous solution into contact with an electrode having an active material layer which includes particles of a first metal oxide, a conductive additive and a binder so as to form, on surfaces of the particles of the first metal oxide, particles of a second metal oxide that is an oxide of the metal in the metal-fluoro complex

Electrochemical devices which use the active material and the electrode obtained according to the present invention have a good charge-discharge cycle performance at high temperatures (e.g., 45 to 55° C.) compared with the prior-art. Although the reason for this is not entirely clear, when the surfaces of the first metal oxide particles serving as the active material are coated with particles of the second metal oxide, the extraction of elements from the first metal oxide particles serving as the active material by the electrolyte solution is suppressed, which discourages electrolyte solution/electrolyte decomposition reactions and the fracture of first metal oxide crystals and also enhances the thermal stability of the first metal oxide particles serving as the active material. In particular, because the second metal oxide particles formed according to the present invention adhere well to the first metal oxide particles serving as the active material, when an electrode is manufactured using such an active material (during electrode manufacture, a coating containing the active material, a conductive additive and other ingredients is prepared, at which time a mixing operation is carried out; if the degree of adhesion is inadequate, particles of the second metal oxide will separate from the first metal oxide particles serving as the active material), good adherence between the first metal oxide serving as the active material within the electrode and the second metal oxide particles can easily be maintained. This makes it possible to suitably carry out charging out at a higher voltage than before, enabling the volumetric energy density to be increased. For example, it is highly effective to use as the first metal oxide an oxide containing lithium and at least one metal selected from the group consisting of cobalt, nickel and manganese, such as LiCoₓNi_{y}Mn_{1-x-y}O₂. Also, even when charging is carried out at the same voltage as in the past, the cycle performance is improved. Moreover, when spinel manganese such as LiMn₂O₄ is used as the first metal oxide, the extraction of manganese ions by the electrolyte solution is suppressed, resulting in a better high-temperature cycle performance.

The metal-fluoro complex is at least one selected from the group consisting of hexafluorozirconic acid and salts thereof, hexafluorosilicic acid and salts thereof, hexafluorotitanic acid and salts thereof, tin fluoride, indium fluoride, magnesium fluoride, zinc fluoride and aluminum fluoride. The effect thereby achieved is for particles of the second metal oxide composed of the metal in these compounds to deposit onto the surface of the first metal oxide particles.

The metal-fluoro complex-containing aqueous solution preferably also includes a scavenger which chemically captures fluoride ions from the metal-fluoro complex. This causes the equilibrium of formula (1) to shift to the right, making it possible to accelerate deposition of the second oxide.

Examples of the scavenger include boric acid, aluminum, ferrous chloride, fernic chloride, sodium hydroxide, ammonia, titanium, iron, nickel, magnesium, copper, zinc, silicon, silicon dioxide, calcium oxide, bismuth oxide, aluminum oxide and magnesium oxide. Of these, boric acid or aluminum is preferred.

The first metal oxide serving as the active material is preferably a lithium-containing metal oxide; LiMn₂₋ₓAlₓO₄ (where 0≦x<2), LiCoₓNi_{y}M_{1-x-y}O₂ (where x and y exceed 0 and are less than 1), LiNiₓCo_{y}Al_{1-x-y}O₂ (where x and y exceed 0 and are less than 1) or Li₄Ti₅O₁₂ is preferred.

The aqueous solution when forming the particle of the second metal oxide has a pH of preferably from 5 to 12. Although the pH of the aqueous solution sometimes fluctuates during formation of the particles of the second metal oxide, at a pH below 5, dissolution of the first metal oxide may occur, and at a pH above 12, metal ions of the metal-fluoro complex may form a hydroxide in the aqueous solution and precipitate. Accordingly, by maintaining the pH of the aqueous solution in a range of from 5 to 12, particles of the second metal oxide can be suitably formed.

Also, it is preferable for the method of the invention to further include a step of heat-treating at from 500 to 900° C. the particles of the first metal oxide on which the particles of the second metal oxide have been formed. In this way, the particles of the second metal oxide can be rendered into single crystals.

The active material of the present invention includes particles of a first metal oxide, and particles of a second metal oxide which coat the first metal oxide particles. The second metal oxide particles have an adhesive force to the first metal oxide particles of at least 0.1 μN.

Another active material according to the invention includes particles of a first metal oxide, and particles of a second metal oxide which coat the first metal oxide particles. The particles of the second metal oxide contain fluorine and/or boron.

Such an active material can be easily produced by the above-described method. Electrochemical devices in which such active materials and electrodes are used have a good charge-discharge cycle performance at high temperatures (e.g., from 45 to 55° C.).

It is preferable for the particles of the second metal oxide to have an average particle diameter of 50 nm or less.

At an average particle diameter for the second metal oxide particles of 50 nm or less, a cycle performance-improving effect tends to be more readily achievable. As used herein, “average particle diameter for the second metal oxide particles” refers to the diameter in a direction along the surface of the first metal oxide particles, not the diameter in the thickness direction.

The weight ratio of the second metal oxide particles, based on the combined weight of the first metal oxide particles and the second metal oxide particles, is preferably from 0.01 wt % to 1.5 wt %.

At a weight ratio of the second metal oxide particles below the lower limit indicated above, a cycle performance-improving effect is difficult to achieve. On the other hand, at a ratio in excess of the upper limit the battery capacity tends to become smaller.

The second metal oxide is preferably at least one selected from the group consisting of zirconium oxide, silicon oxide, titanium oxide, tin oxide, indium oxide, magnesium oxide, zinc oxide and aluminum oxide. Tetragonal or monoclinic zirconium oxide is especially preferred.

The particles of the second metal oxide preferably form a layer on the surfaces of the first metal oxide particles, the thickness of the layer preferably being from 1 to 200 nm. Below the lower limit in layer thickness, a cycle performance-improving effect is difficult to achieve, whereas above the upper limit, the battery capacity tends to become smaller. The surface oxide layer may be either lamellar or particulate.

The particles of the second metal oxide preferably include single-crystal particles. Including single-crystal particles improves cycle characteristics when the active material of the invention is used in electrochemical devices.

The electrode of the invention is composed in part of the above-described active material.

The invention thus provides active materials and electrodes capable of achieving a satisfactory cycle performance, and also provides production methods of such active materials and electrodes.

### BRIEF DESCRIPTION OF THE DRAWINGS

FIG. 1 is a schematic cross-sectional view of a lithium ion secondary battery which is an electrochemical device according to one embodiment of the invention;

(a) and (b) of FIG. 2 are schematic cross-sectional views of an active material according to the same embodiment;

FIG. 3 is a cross-sectional micrograph of the active material obtained in Example 6;

FIG. 4 is an EDS mapping image of the active material obtained in Example 15;

FIG. 5 is a high-resolution TEM image of the active material obtained in Example 16;

FIG. 6 illustrates graphs showing TOP-SIMS spectra for the active material obtained in Example 16; (a) is for B⁺, (b) is for BO₂⁻, and (c) is for F⁻;

FIG. 7 illustrates graphs showing TOF-SIMS spectra for the active material obtained in Comparative Example 3; (a) is for B⁺, (b) is for BO₂⁻, and (c) is for F⁻.

FIG. 8 is a cross-sectional micrograph of the active material obtained in Example 17;

FIG. 9 is an EDS mapping image of the active material obtained in Example 17;

FIG. 10 is a cross-sectional micrograph of the active material obtained in Example 22;

FIG. 11 is an EDS mapping image of the active material obtained in Example 22;

FIG. 12 is an EDS mapping image of the active material obtained in Example 22;

FIG. 13 is an EDS mapping image of the electrode obtained in Example 22; and

FIG. 14 is an EDS mapping image of the active material obtained in Comparative Example 12.

### DESCRIPTION OF THE PREFERRED EMBODIMENTS

Preferred embodiments of the invention are described below in conjunction with the appended diagrams. In the descriptions of the diagrams, like or corresponding elements are denoted by like reference symbols and the unnecessary repetition of explanations is avoided. Relative dimensions of features shown in the diagrams may not be true to scale.

Electrochemical Device

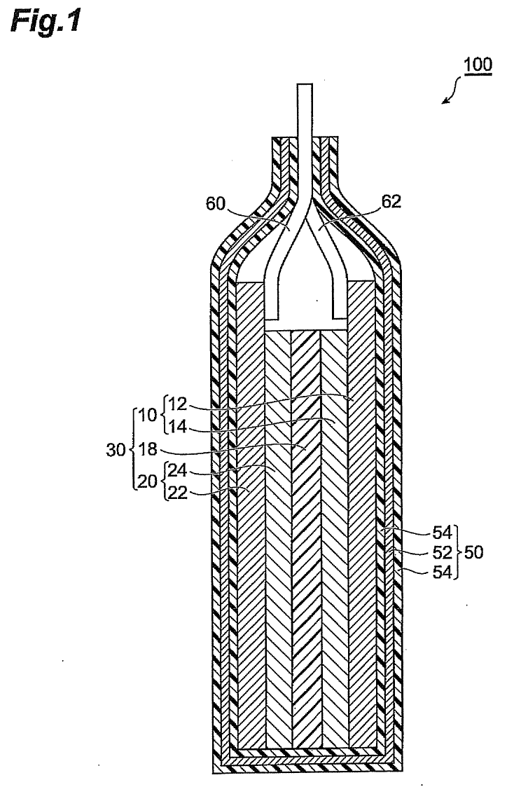

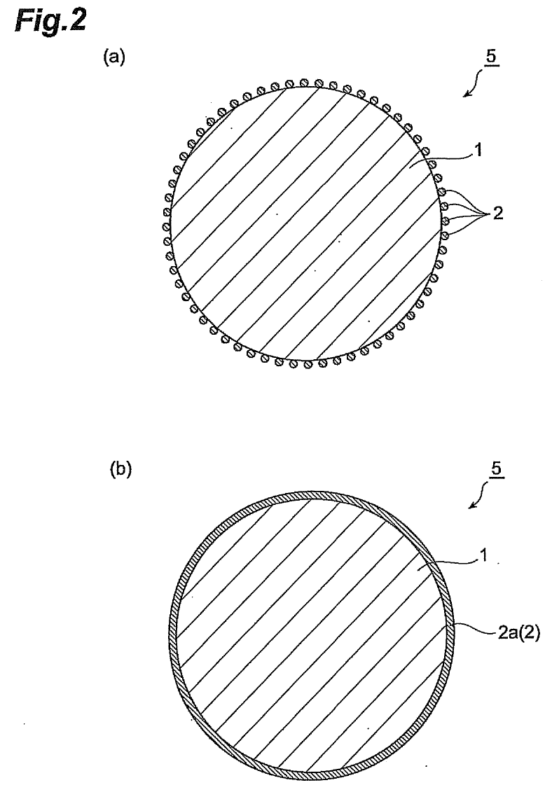

First, a brief description is provided, while referring to FIG. 1, of a lithium ion secondary battery as an electrochemical device which uses the active material and electrode of the invention.

The lithium ion secondary battery 100 is composed primarily of a stack 30, a case 50 which houses the stack 30 in a sealed state, and a pair of leads 60 and 62 connected to the stack 30.

The stack 30 is composed of a pair of electrodes 10 and 20 which are disposed opposite each other with a separator 18 therebetween. The positive electrode 10 is composed of a positive electrode current collector 12 on which has been provided a positive electrode active material layer 14. The negative electrode 20 is composed of a negative electrode current collector 22 on which has been provided a negative electrode active material layer 24. The positive electrode active material layer 14 and the negative electrode active material layer 24 are respectively in touch with the two sides of the separator 18. One lead 60 is connected to the end of the negative electrode current collector 22 and the other lead 62 is connected to the end of the positive electrode current collector 12, and the end of each of the leads 60 and 62 extends out to the exterior of the case 50.

### First Embodiment

### Positive Electrode and Method of Manufacture

An embodiment of the invention is described. In the present embodiment, a positive electrode active material composed of particles of a first metal oxide on the surface of which hare formed particles of a second metal oxide is produced. This surface-modified positive electrode active material is used to produce a positive electrode.

Method of Producing Positive Electrode Active Material

First, particles of a first metal oxide are furnished. The first metal oxide is not subject to any particular limitation so long as it functions as an active material for a positive electrode. A lithium-containing metal oxide is preferred as the first metal oxide. Even among lithium-containing metal oxides, a metal oxide containing lithium and at least one metal selected from the group consisting of cobalt, nickel, manganese and aluminum, such as LiMn₂O₄, LiMn₂₋ₓAlₓO₄ (where x exceeds 0 and is less than 2), LiMO₂ (where M represents cobalt, nickel or manganese), LiCoₓNi₁₋ₓO₂ or LiCoₓNi_{y}Mn_{1-x-y}O₂ (where x and y exceed 0 and are less than 1) or LiNiₓCo_{y}Al_{1-x-y}O₂ (where x and y exceed 0 and are less than 1), is preferred. LiNi_{1/3}Mn_{1/3}Co_{1/3}O₂ and L_{0.8}Co_{0.15}M_{0.05} are especially preferred. Li₄Ti₅O₁₂ is also preferred.

The particles of the first metal oxide have a diameter which, while not subject to any particular limitation, is preferably from about 0.5 μm to about 30 μm.

Next, a metal-fluoro complex-containing aqueous solution is furnished. Examples of the metal in the metal-fluoro complex include zirconium, silicon, titanium, tin, indium, magnesium, zinc and aluminum.

Specific examples of the metal-fluoro complex include at least one selected from the group consisting of hexafluorozirconic acid (H₂ZrF₆) and salts thereof, hexafluorosilicic acid (H₂SiF₆) and salts thereof, hexafluorotitanic acid (H₂TiF₆) and salts thereof, tin fluorides (SnF₂, SnF₄), indium fluoride (InF₃), magnesium fluoride (MgF₂), zinc fluoride (ZnF₂) and aluminum fluoride (AlF₃).

Metal-fluoro complex salts are exemplified by potassium salts, calcium salts and ammonium salts. Specific examples include K₂ZrF₆, K₂SiF₆, K₂TiF₆, CaZrF₆, CaSiF₆, CaTiF₆, (NH₄)₂ZrF₆, (NH₄)₂SiF₆ and (NH₄)₂TiF₆.

Metal-fluoro complexes such as these may be obtained by, for example, dissolving a metal compound which is not a fluoro complex in an aqueous solution of hydrofluoric acid (HF) or an aqueous solution of ammonium hydrogen difluoride (NH₄F.HF). For example, when iron oxyhydroxide (FeOOH) or cobalt hydroxide (Co(OH)₂) is dissolved in an aqueous solution of NH₄.HF, a metal-fluoro complex such as FeF₆³⁻ or CoF₆⁴⁻ forms in the aqueous solution and can be used in the present invention.

The concentration of the metal-fluoro complex in the aqueous solution is preferably from about 0.001 M to about 1 M. Here, M stands for mol/L.

It is preferable to include in this aqueous solution a scavenger capable of withdrawing fluoride ions (F⁻) from the metal-fluoro complex. By adding a scavenger, surface modification can be rapidly carried out.

Examples of scavengers that may be used include boric acid (H₃BO₃), aluminum (Al), ferrous chloride (FeCl₂), ferric chloride (FeCl₃), sodium hydroxide (NaOH), ammonia (NH₃), titanium (Ti), iron (Fe), nickel (Ni), magnesium (Mg), copper (Cu), zinc (Zn), silicon (Si), silicon dioxide (SiO₂), calcium oxide (CaO), bismuth oxide (Bi₂O₃), aluminum oxide (Al₂O₃) and magnesium oxide (MgO).

When boric acid is used, the concentration in the treatment solution is preferably set to from about 0.001 M to about 1 M.

Particles of the first metal oxide are brought into contact with this metal-fluoro complex-containing aqueous solution. That is, particles of the first metal oxide are added to the metal-fluoro complex-containing aqueous solution, and stirring is carried out if necessary. Alternatively, instead of mixing together the metal-fluoro complex-containing aqueous solution and boric acid from the start, particles of the first metal oxide may be dispersed in an aqueous solution of boric acid, and the metal-fluoro complex-containing aqueous solution added to the resulting dispersion in a dropwise manner.

In the aqueous solution, the following equilibrium reaction occurs:

MFₓ^{(x-2n)}+nH₂O [symbol] MOₙ+xF⁻+2nH⁺ (1).

When H₃BO₃ or aluminum is present as the scavenger, the reaction becomes:

H₃BO₃+4H⁺+4F⁻=HBF₄+3H₂O (2)

or Al+6H⁺+6F⁻=H₃AlF₆+ 3/2H₂ (3),

shifting the equilibrium of formula (1) to the right side.

Specifically, as shown in formula (2), boric acid reacts with fluoride ions to form HBF₄. When the fluoride ions are consumed, the equilibrium of formula (1) moves to the right, accelerating the formation of the second metal oxide MOₙ. Also, as shown in formula (3), aluminum reacts with fluoride ions to form H₃AlF₆. As a result, in formula (1), the equilibrium shifts in the second metal oxide MOₙ forming direction.

As shown in (a) of FIG. 2, such treatment gives an active material 5 composed of first metal oxide particles 1 on the surface of which have been formed particles 2 of the second metal oxide. Here, the second metal oxide is an oxide of the metal originating from the metal-fluoro complex, and differs from the first metal oxide. Moreover, the foregoing treatment enables the adhesive force of the second metal oxide particles 2 to the first metal oxide particles 1 to be set to at least 0.1 μN, and preferably at least 0.5 μN. The second metal oxide particles 2 generally contain fluorine and/or boron. For example, the fluorine concentration, based on the overall active material (first metal oxide particles+second metal oxide particles), may be from 50 to 1,000 weight ppm, and the boron concentration may be from 10 to 1,000 weight ppm.

The adhesive force of the second metal oxide particles 2 can be measured by a scratch test using a nanoindentation tester. A nanoindentation tester is an apparatus which makes it possible to quantitatively determine mechanical properties by pushing an indenter into a specimen of the active material 5 while controlling the indenter at nanometer-order positioning precision and μN-order loading precision, then analyzing the load-displacement curve. The following two steps should be carried out to measure adhesion, i.e., the adhesive force, between particles 1 of the first metal oxide and particles 2 of the second metal oxide.

First, the active material serving as the specimen is fixed to a substrate with an adhesive and is checked with an atomic force microscope (AFM; Nanoscope IIa+D3100, manufactured by Digital Instruments) to ensure that it is in a monodispersed state with no overlap. The verification conditions may be, for example, a tapping mode, an open-air atmosphere, and a measurement region of 5 μm×5 μm or 500 nm×500 nm. The specimen may then be measured with a nanoindentation tester (e.g., TriboIndenter, manufactured by Hysitron). Specifically, a constant vertical load is applied to the specimen with the indenter (e.g., a triangular pyramidal indenter having a spherical tip with a radius of curvature of 1 to 50 nm), following which the indenter is moved in the horizontal direction (this is referred to as “scratching”), and the average coefficient of friction is measured. The constant vertical load applied with the indenter is varied among four or more levels and the average coefficient of friction at each vertical load is measured. Next, plotting the vertical load on the abscissa and the average coefficient of friction on the ordinate, the vertical load at which the average coefficient of friction begins to abruptly change can be treated as the adhesive force between particles 1 of the first metal oxide and particles 2 of the second metal oxide.

While there is no particular upper limit in the adhesive force of the particles 2 of the second metal oxide to the particles 1 of the first metal oxide, the first metal oxide particles 1 have a tendency to expand and shrink during charging and discharging. At this time, if the particles 2 of the second metal oxide particles are too strongly attached to the particles 1 of the first metal oxide, small cracks tend to arise in the particles 1 of the first metal oxide. For this reason, the adhesive force of the second metal oxide particles 2 to the first metal oxide particles 1 is preferably 10 μN or less, and more preferably 3 μN or less.

The particles 2 of the second metal oxide have an average diameter of preferably 50 nm or less. At an average second metal oxide particle diameter of 50 nm or below, a cycle performance-improving effect tends to be more readily achievable. Here, the diameter of the particles 2 of the second metal oxide refers to the diameter in a direction along the surface of the particles of the first metal oxide, not the diameter in the thickness direction. Such a diameter can easily be measured from cross-sectional electron micrographs taken at a high resolution, and the average particle diameter can easily be obtained by determining the number mean diameter.

The weight of the second metal oxide particles 2 based on the combined weight of the first metal oxide particles 1 and the second metal oxide particles 2 is preferably set to from 0.01 wt % to 1.5 wt %.

At a weight ratio for the particles 2 of the second metal oxide below the above-indicated lower limit, a cycle performance-improving effect does not readily arise. On the other hand, at a weight ratio greater than the above-indicated upper limit, the battery capacity tends to become small. Also, when the average diameter of the particles 2 of the second metal oxide exceeds 50 nm, a cycle performance-improving effect is less readily achievable.

As shown in (a) of FIG. 2, particles 2 of the second metal oxide often adhere to part of the surface of a first metal oxide. However, particles 2 of the second metal oxide sometimes form a layer 2a on the surface of a particle 1 of the first metal oxide, as shown in (b) of FIG. 2. The thickness of the layer 2a in such a case, while not subject to any particular limitation, may be, for example, from 1 to 200 nm, and is preferably from 10 to 100 nm.

The average diameter of the particles 2 of the second metal oxide, the weight ratio of particles 2 of the second metal oxide with respect to the combined weight of the particles 1 of the first metal oxide and the particles 2 of the second metal oxide, and the formation or lack of formation of a layer 2a as well as the thickness of the layer 2a can be easily controlled by setting the period and temperature of contact between the first metal oxide particles 1 and the aqueous solution and the concentrations of the metal-fluoro complex and the scavenger to appropriate values.

The aqueous solution when forming the particles of the second metal oxide has a pH of preferably from 5 to 12. During formation of the second metal oxide particles, the pH of the aqueous solution often fluctuates, as shown, for example, due to the formation of H⁺ according to formula (1). Moreover, at a pH below 5, dissolution of the first metal oxide may occur, and at a pH above 12, metal ions of the metal-fluoro complex in the aqueous solution may form a hydroxide and precipitate. Therefore, by maintaining the pH of the aqueous solution during the formation of particles of the second metal oxide in a range of from 5 to 12, particles of the second metal oxide can be suitably formed on particles of the first metal oxide. Examples of ways for maintaining the pH of the aqueous solution during formation of the second metal oxide particles in the above range include: anticipating the pH range of fluctuation and setting the pH of the aqueous solution prior to second metal oxide particle formation in such a way that the pH at the completion of second metal oxide particle formation falls within the above range; and carrying out the addition of an acid (hydrochloric acid) or a base (ammonia water) in the course of second metal oxide particle formation.

Once a battery active material 5 in which particles 2 of the second metal oxide have been formed on the surface of particles 1 of the first metal oxide is obtained by such treatment, the aqueous solution and the active material 5 are separated by a suitable technique such as filtration, following which the active material 5 is rinsed with water or the like and dried. In addition, if necessary, heat treatment is carried out so as to increase the crystallinity of the second metal oxide. By increasing the crystallinity of the second metal oxide, the decomposition of electrolyte solution at the surface of first metal oxide particles 1 is suppressed, further enhancing the cycle performance.

The heat treatment temperature is not subject to any particular limitation, although a temperature in a range of from 500 to 900° C. is preferred. In this way, particles of the second metal oxide can be suitably rendered into single crystals. The heat treatment atmosphere is not subject to any particular limitation, although an open-air atmosphere is preferred. Conversion of the second metal oxide particles to single crystals makes it easier to improve the cycle characteristics.

Method of Manufacturing Positive Electrode

The active material 5 is then used to produce an electrode 10. First, a binder, a current collector 12 and a conductive additive are furnished.

The binder is not subject to any particular limitation, provided it can be used to bind the above-described battery active material and the conductive additive to the current conductor. Known binders may be used for this purpose. Illustrative examples include fluorocarbon resins such as polyvinylidene fluoride (PVDF) and polytetrafluoroethylene (PTFE), and mixtures of a styrene-butadiene rubber (SBR) with a water-soluble polymer (e.g., carboxymethylcellulose, polyvinyl alcohol, sodium polyacrylate, dextrin, gluten).

Next, a current conductor 12 is furnished. An example of a suitable current conductor 12 is aluminum foil.

The conductive additive is exemplified by carbon materials such as carbon black, metal powders such as copper, nickel, stainless steel and iron, mixtures of carbon materials and metal powders, and conductive oxides such as indium-doped tin oxide (ITO).

The above-described active material 5, binder and conductive additive are added to a solvent so as to prepare a slurry. Examples of solvents that may be used for this purpose include N-methyl-2-pyrrolidone and water.

The slurry containing the active material, the binder and the conductive additive is coated onto the surface of the current collector 12 and dried, thereby completing the production of a positive electrode 10 having, as shown in FIG. 1, a positive electrode current collector 12 and a positive electrode active material layer 14.

Method of Manufacturing Negative Electrode

The negative electrode 20 can be manufactured by a known method. Specifically, copper foil or the like may be used as the negative electrode current collector 22. The negative electrode active material layer 24 may be one that includes a negative electrode active material, a conductive additive and a binder. The conductive additive and the binder may be of the same type as those used in the positive electrode.

Illustrative examples of the negative electrode active material include carbon materials such as graphite capable of intercalating and deintercalating (or doping and dedoping) lithium ions, non-graphitizable carbons, readily graphitizable carbons and low-temperature fired carbons; metals which combine with lithium, such as aluminum, silicon and tin; amorphous compounds composed primarily of an oxide such as SiO₂ or SnO₂, and particles containing lithium titanate (Li₄Ti₅O₁₂).

The negative electrode 20 may be produced in a manner similar to that used for producing the positive electrode 10; that is, by preparing a slurry and coating it onto the current collector.

Method of Manufacturing Electrochemical Device

In addition to the above-described positive electrode and negative electrode, the following are also furnished: an electrolyte solution, a separator 18, a case 50 and leads 60 and 62.

The electrolyte solution is included at the interior of the positive electrode active material layer 14, the negative electrode active material layer 24 and the separator 18. The electrolyte solution is not subject to any particular limitation. For example, in the present embodiment, use may be made of an electrolyte solution (an aqueous electrolyte solution or an electrolyte solution which use an organic solvent) containing a lithium salt. However, aqueous electrolyte solutions have a low electrochemical decomposition voltage, limiting to a low value the voltage that can be used during charging. Hence, an electrolyte solution which uses an organic solvent (i.e., a nonaqueous electrolyte solution) is preferred. The electrolyte solution is preferably a solution prepared by dissolving a lithium salt in a nonaqueous solvent (an organic solvent). Examples of lithium salts that may be used include LiPF₆, LiClO₄, LiFB₄, LiAsF₆, LiCF₃SO₃, LiCF₃, CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂ and LiBOB. These salts may be used singly or as combinations of two or more thereof.

Preferred examples of the organic solvent include propylene carbonate, ethylene carbonate and diethyl carbonate. These may be used alone or two or more may be mixed and used together in any suitable proportion.

In the present embodiment, the electrolyte solution is not limited to the form of a liquid, and may instead be a gel-type electrolyte obtained by the addition of a gelling agent. Alternatively, a solid electrolyte (a solid polymer electrolyte or an electrolyte composed of an ion-conductive inorganic material) may be included instead of an electrolyte solution.

The separator 18 is typically formed of an electrically insulating porous material. Illustrative examples include single-layer films or laminates of polyolefin (ex. polyethylene and polypropylene), stretched films composed of mixtures of the foregoing resins, and fibrous nonwoven fabrics composed of at least one material selected from the group consisting of celluloses, polyesters and polypropylenes.

The case 50 hermetically seals at the interior thereof the stack 30 and the electrolyte solution. The case 50 is not subject to any particular limitation, provided it is capable of checking the external leakage of electrolyte solution and the infiltration of outside moisture, etc. into the electrochemical device 100. For example, as shown in FIG. 1, a metal laminate film composed of a metal foil 52 coated on either side with a polymer film 54 may be used as the case 50. By way of illustration, aluminum foil may be used as the metal foil 52, and a film made of polypropylene or the like may be used as the synthetic resin film 54. The material making up the outer polymer film 54 is preferably a high-melting polymer such as polyethylene terephthalate (PET) or polyamide, and the material making up the inner polymer film 54 is preferably polyethylene, polypropylene or the like.

The leads 60 and 62 are formed of a conductive material such as aluminum.

Typically, one lead 60 is welded to the negative electrode current collector 22 and the other lead 62 is welded to the positive electrode current collector 12 by a method known to the art, the stack 30 assembled by interposing the separator 18 between the active material layer 14 of the positive electrode 10 and the active material layer 24 of the negative electrode 20 is inserted together with the electrolyte solution into the case 50, and the opening of the case 50 is sealed.

In the electrochemical device of the present embodiment, an active material 5 having particles 2 of the second metal oxide on the surface of particles 1 of the first metal oxide is used, the second metal oxide particles 2 having an adhesive force to the first metal oxide particles 1 of 0.1 μN or more. As a result, the deterioration in capacity with repeated charging and discharging decreases, giving an excellent cycle performance. This appears to involve at least one of the following effects: the decomposition or deterioration of the electrolyte solution or the electrolyte by the first metal oxide when charging is carried out is suppressed, the fracturing of crystals of the first metal oxide is suppressed, and the thermal stability of the first metal oxide is improved. The reason why such effects are obtained with the active material 5 of the present embodiment is not entirely clear, although it does appear that, for example, the formation of particles 2 of the second metal oxide on the surface of particles 1 of the first metal oxide has the effect of suppressing the extraction of elements from the particles 1 of the first metal oxide into the electrolyte solution, inhibiting electrolyte solution or electrolyte decomposition reactions and the fracture of crystals of the first metal oxide, or improving the thermal stability of the first metal oxide.

In the present embodiment in particular, because particles 2 of the second metal oxide have an adhesive force to particles 1 of the first metal oxide of 0.1 μN or more, adhesion between the first metal oxide particles 1 and the second metal oxide particles 2 is excellent. Hence, when electrodes are produced using this active material 5, the particles 2 of the second metal oxide do not readily separate from the particles 1 of the first metal oxide even when the active material 5 is subjected to such treatment operations as kneading and agitation. Therefore, when a battery is produced, it appears that the electrolyte solution and electrolyte decomposition and deterioration-suppressing effect, the first metal oxide crystal fracture-suppressing effect, and the first metal oxide thermal stability-enhancing effect are more easily achieved that with coated particles produced by conventional methods. The adhesive force described above is attainable only by using the above-described method to obtain the active material 5.

It is thus possible, by way of the present embodiment, to exhibit good charge/discharge cycling even when charging is carried out at a higher voltage than normal, thus enabling charging to be carried out at a higher voltage than in the prior art. This tendency is especially clear when a metal oxide containing lithium and a metal other than lithium, particularly LiCoₓNi_{y}Mn_{1-x-y}O₂ or LiNiₓCo_{y}Al_{1-x-y}O₂, is used as the first metal oxide.

### Second Embodiment

A second embodiment of the invention is described. In the present invention, a positive electrode 10 which contains a positive electrode active material layer 14 is initially produced using particles 1 of the first metal oxide prior to formation of the particles 2 of the second metal oxide. The positive electrode 10 is then brought into contact with a metal-fluoro complex-containing aqueous solution, thereby forming particles 2 of the second metal oxide on the surface of particles 1 of the first metal oxide within the positive electrode active material layer 14. That is, the particles 1 of the first metal oxide within the positive electrode active material layer 14 are modified.

Aside from using particles of the first metal oxide which have not been surface modified, the method of manufacturing the positive electrode 10 is the same as in the first embodiment. The metal-fluoro complex-containing aqueous solution which is brought into contact with the positive electrode 10 is also the same as in the first embodiment. The same contacting conditions may be employed as in the first embodiment. In particular, when the current collector 12 of the positive electrode 10 is aluminum, this aluminum functions as a scavenger, making it easy to promote surface modification. When the aluminum serving as the current collector is used as a scavenger, the aluminum current collector will corrode, but it will not corrode to the extent of impeding its function as a current collector.

In the present embodiment, by treating the positive electrode, the surfaces of the first metal oxide particles 1 in the positive electrode active material layer are modified in the same way as in the first embodiment, resulting in the formation of particles 2 of the second metal oxide. As a result, the same effects as in the first embodiment appear.

In the above embodiments, particles 2 of the second metal oxide are formed on the surfaces of particles 1 of the first metal oxide in the positive electrode active material. In cases where the negative electrode active material particles are made of a metal oxide, by carrying out the formation of particles 2 of the same second metal oxide on particles of the first metal oxide serving as the negative electrode active material, similar effects are achieved. For example, the use of a metal oxide such as Li₄Ti₅O₁₂ or SiOₓ (x<2) as the first metal oxide in the negative electrode active material is highly effective.

The above embodiments are described in connection with secondary batteries, although similar effects may be achieved as well in other electrochermical devices such as electric double-layer capacitors and hybrid electric double-layer capacitors. For example, in an electric double-layer capacitor, the use of a metal oxide such as RuO₂ as the active material is highly effective.

### EXAMPLE 1

In Example 1, LiMn₂O₄ was used as the first metal oxide in the positive electrode.

### Surface Modification of First Metal Oxide by Zirconium-Fluoro Complex

K₂ZrF₆ (manufactured by Junsei Chemical Co., Ltd.) and H₃BO₃ (manufactured by Kanto Chemical Co., Inc.) were dissolved in water to respective concentrations of 0.01 M and 0.05 M (this solution is referred to below as the “LPD treatment solution”). Next, 120 g of LiMn₂O₄ particles were added to 800 ml of this solution, and reaction was effected by stirring for 24 hours while warming at 40° C.

The resulting dispersion was filtered, thereby giving LiMn₂O₄ particles coated on the surface with ZrO₂ particles. The filtrate had a pH of 5.9. These LiMn₂O₄ particles were rinsed with water and dried at 80° C., then heat-treated in an open-air atmosphere at 700° C. for 2 hours. The weight ratio of zirconium in these positive electrode active material particles (LiMn₂O₄+ZrO₂), as measured by induction-coupled plasma emission spectroscopy (ICP), was 0.15 wt %. This amount of zirconium was equivalent to a ZrO₂ content of 0.20 wt %. The positive electrode active material, when analyzed with a scanning transmission electron microscope (STEM), was found to have ZrO₂ particles with an average particle diameter of 20 nm attached to the surface of the LiMn₂O₄ particles. The adhesive force of the ZrO₂ particles, as measured by the above-described scratch test, was 1.3 μN

Manufacture of Battery Electrodes Positive Electrode:

A positive electrode was manufactured using the surface-modified positive electrode active material prepared above as the battery active material, using carbon black (also abbreviated below as “CB”; DAB50, manufactured by Denki Kagaku Kogyo KK) and graphite (KS-6, manufactured by Timcal KK) as the conductive additive, and using polyvinylidene fluoride (also abbreviated below as “PVDF”; KF7305, manufactured by Kureha Chemical Industry Co., Ltd.) as the binder. A coating was prepared by adding an N-methyl-2-pyrrolidone (NMP) solution of PVDF (KF7305) to the positive electrode active material, CB and graphite, then mixing. The coating was applied to aluminum foil (thickness, 20 μm) as the current collector by the doctor blade method, then dried (100° C.) and rolled.

Negative Electrode:

A negative electrode was manufactured using natural graphite as the battery active material, CB as the conductive additive, and PVDF as the binder. A coating was prepared by adding KF7305 to the natural graphite and CB, then mixing. The coating was applied to copper foil (thickness, 16 μm) as the current collector by the doctor blade method, then dried (100° C.) and rolled.

Manufacture of Battery

The positive and negative electrodes manufactured above and the separator (a microporous membrane made of polyolefin) were cut to a specific size. The positive and negative electrodes were provided with uncoated areas (areas not coated with the electrode coating composed of the active material+conductive additive+binder) for the purpose of welding thereto external lead-out terminals. The positive electrode, negative electrode and separator were stacked in this order. During stacking, the positive electrode, negative electrode and separator were held in place by applying small amounts of hot-melt adhesive (ethylene-methacrylic acid copolymer (EMAA)) to prevent movement therebetween. Strips of aluminum foil (width, 4 mm; length, 40 mm; thickness, 100 μm) and nickel foil (width, 4 mm; length, 40 mm; thickness, 100 μm) were ultrasonically welded as external lead-out terminals to the positive electrode and the negative electrode, respectively. Maleic anhydride-grafted polypropylene (PP) was wrapped about and thermally bonded to the external lead-out terminals so as to improve the sealability of the external terminals and the battery housing. The housing which encloses the stacked battery elements (positive electrode, negative electrode, and separator) was made of an aluminum laminate having the following construction: PET (12)/Al (40)/PP (50). Here, PET stands for polyethylene terephthalate, PP stands for polypropylene, and the numbers appearing in parentheses indicate the thicknesses of the respective layers in micrometers. The housing is made as a pack with the polypropylene layer on the inside. The battery elements were placed inside the housing, following which a suitable amount of the electrolyte solution (LiPF6 dissolved to a concentration of 1 M in a mixed solvent of ethylene carbonate (EC) and diethyl carbonate (DEC) (EC:DEC=30:70 vol %)) was added and the housing was vacuum sealed, thereby producing an electrochemical device (a lithium ion secondary battery).

Measurement of Electrical Properties

The battery was constant-current, constant-voltage charged at 1 C to 4.2 V, then discharged at 1 C to 3.0 V. This cycle was repeated 300 times (cycle test) at a test temperature of 55° C. Letting the initial discharge capacity be 100%, the discharge capacity after 300 cycles was 70%.

### EXAMPLE 2

Aside from changing the concentrations of K₂ZrF₆ and H₃BO₃ in the LPD treatment solution to 0.04 M and 0.2 M, respectively, the same procedure was carried out as in Example 1. The weight ratio of ZrO₂ in this positive electrode active material was 0.51 wt %. The ZrO₂ particles had an average particle diameter of 40 nm and an adhesive force of 1.5 μN. The discharge capacity after 300 cycles was 75% of the initial discharge capacity.

### EXAMPLE 3

Aside from changing the concentrations of K₂ZrF₆ and H₃BO₃ in the LPD treatment solution to 0.005 M and 0.025 M, respectively, and setting the reaction time to 20 minutes, the same procedure was carried out as in Example 1. The weight ratio of ZrO₂ in this positive electrode active material was 0.07 wt %. The ZrO₂ particles had an average particle diameter of 20 nm and an adhesive force of 1.0 μN. The discharge capacity after 300 cycles was 65% of the initial discharge capacity.

### EXAMPLE 4

Aside from changing the concentrations of K₂ZrF₆ and H₃BO₃ in the LPD treatment solution to 0.06 M and 0.3 M, respectively, the same procedure was carried out as in Example 1. The weight ratio of ZrO₂ in this positive electrode active material was 0.81 wt %. The ZrO₂ particles had an average particle diameter of 40 nm and an adhesive force of 2.0 μN. The discharge capacity after 300 cycles was 80% of the initial discharge capacity.

### EXAMPLE 5

The concentrations of K₂ZrF₆ and H₃BO₃ in the LPD treatment solution were changed to 0.06 M and 0.3 M, respectively, then 120 g of LiMn₂O₄ particles was added to 800 ml of the solution and sting was carried out for 24 hours under warming at 40° C. The resulting dispersion was filtered, giving LiMn₂O₄ particles coated with zirconia particles. These coated LiMn₂O₄ particles were then dispersed in 800 ml of fresh LPD treatment solution (containing K₂ZrF₆ and H₃BO₃ in respective concentrations of 0.06 M and 0.3 M), and stirring was carried out for 24 hours under warming at 40° C. Subsequent operations were carried out exactly as in Example 1. The weight ratio of ZrO₂ in the positive electrode active material was 1.13 wt %. The ZrO₂ particles had an average particle diameter of 40 nm and an adhesive force of 1.0 μN. The discharge capacity after 300 cycles was 85% of the initial discharge capacity.

### EXAMPLE 6

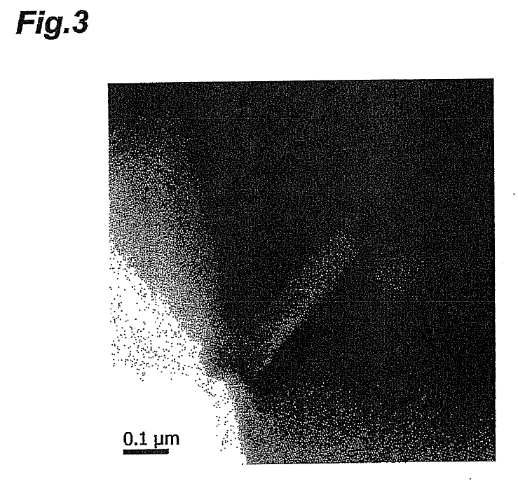

The first metal oxide in the positive electrode was changed from LiMn₂O₄ to LiMn_{1.9}Al_{0.1}O₄, and the concentrations of K₂ZrF₆ and H₃BO₃ in the LPD treatment solution were changed to 0.04 M and 0.2 M, respectively. First, 120 g of the LiMn_{1.9}Al_{0.1}O₄ particles was added to 800 ml of the solution and stirring was carried out for 3 hours under warming at 40° C. The resulting dispersion was filtered, giving LiMn_{1.9}Al_{0.1}O₄ particles coated with zirconia particles. Subsequent operations were carried out exactly as in Example 1. The weight ratio of ZrO₂ in the positive electrode active material was 0.62 wt %. The positive electrode active material was analyzed by scanning transmission electron microscope (STEM), whereupon ZrO₂ particles having an average particle diameter of 20 nm were found to be attached to the surface of the active material as a coat. The ZrO₂ particles had an adhesive force of 2.0 μN. A cross-sectional micrograph is shown in FIG. 3. The white patches in FIG. 3 are ZrO₂ particles. Specimen preparation was carried out as follows. The specimen was blended together with an epoxy resin, then solidified into a plate. A portion of the specimen mixed with the above resin was then thinned to a film by argon ion milling, and the resulting thin-film sample was examined under a JEM-2100F scanning transmission electron microscope (STEM, manufactured by JEOL Ltd.). The discharge capacity after 300 cycles was 77% of the initial discharge capacity.

### COMPARATIVE EXAMPLE 1

Aside from using LiMn₂O₄ that was not coated with particles of the second metal oxide, a battery was produced in exactly the same way as in Example 1. The discharge capacity after 300 cycles was 50%.

### COMPARATIVE EXAMPLE 2

Aside from using LiMn_{1.9}Al_{0.1}O₄ that was not coated with particles of the second metal oxide, a battery was manufactured in exactly the same way as in Example 6. The discharge capacity after 300 cycles was 60%.

In these examples and comparative examples, the first metal oxide was a spinel compound such as LiMn₂O₄ or LiMn_{1.9}Al_{0.1}O₄. However, in the examples described below, LiNi_{1/3}Mn_{1/3}Co_{1/3}O₂ (a lamellar substance) was used as the first metal oxide.

### EXAMPLE 7

The first metal oxide was changed to LiNi_{1/3}Mn_{1/3}Co_{1/3}O₂. The concentrations of K₂ZrF₆ and H₃BO₃ in the LPD treatment solution were adjusted to 0.01 M and 0.05 M, respectively. The treatment solution temperature was set to 30° C., and the reaction time (length of time that the first metal oxide is treated with the LPD treatment solution) was set to 10 minutes. Aside from the above, the same procedure was carried out as in Example 1. The weight ratio of ZrO₂ was 0.53 wt %. ZrO₂ particles having an average diameter of 20 nm were found to be attached to the surfaces of particles of the first metal oxide. The adhesive force of the ZrO₂ particles was 2 μN. The discharge capacity after 300 cycles was 93% of the initial discharge capacity.

### EXAMPLE 8

The reaction time was set to 20 minutes. Aside from the above, the same procedure was carried out as in Example 7. The weight ratio of ZrO₂ particles was 0.59 wt %, the average particle diameter was 75 nm, and the adhesive force was 1.0 μN. The discharge capacity after 300 cycles was 94% of the initial discharge capacity.

### EXAMPLE 9

The reaction time was set to 1 hour. Aside from the above, the same procedure was carried out as in Example 7. The weight ratio of ZrO₂ particles was 0.66 wt %, the average particle diameter was 90 nm, and the adhesive force was 0.3 μN. The discharge capacity after 300 cycles was 79% of the initial discharge capacity.

### EXAMPLE 10

The reaction time was set to 3 hours. Aside from the above, the same procedure was carried out as in Example 7. The weight ratio of ZrO₂ particles was 0.73 wt %, the average particle diameter was 50 nm, and the adhesive force was 0.1 μN. The discharge capacity after 300 cycles was 80% of the initial discharge capacity.

### EXAMPLE 11

The reaction time was set to 24 hours. Aside from the above, the same procedure was carried out as in Example 7. The weight ratio of ZrO₂ particles was 0.76 wt %, the average particle diameter was 200 nm, and the adhesive force was 0.1 μN. The discharge capacity after 300 cycles was 76% of the initial discharge capacity.

### EXAMPLE 12

The treatment solution temperature was set to 40° C. Aside from the above, the same procedure was carried out as in Example 7. The weight ratio of ZrO₂ particles was 0.59 wt %, the average particle diameter was 5 nm, and the adhesive force was 1.3 μN. The discharge capacity after 300 cycles was 94% of the initial discharge capacity.

### EXAMPLE 13

The treatment solution temperature was set to 40° C., and the reaction time was set to 20 minutes. Aside from the above, the same procedure was carried out as in Example 7. The weight ratio of ZrO₂ was 0.63 wt %, the average particle diameter was 70 nm, and the adhesive force was 1.5 μN. The discharge capacity after 300 cycles was 91% of the initial discharge capacity.

### EXAMPLE 14

The treatment solution temperature was set to 40° C., and the reaction time was set to 1 hour. Aside from the above, the same procedure was carried out as in Example 7. The weight ratio of ZrO₂ was 0.69 wt %, the average particle diameter was 70 nm, and the adhesive force was 2.0 μN. The discharge capacity after 300 cycles was 93% of the initial discharge capacity.

### EXAMPLE 15

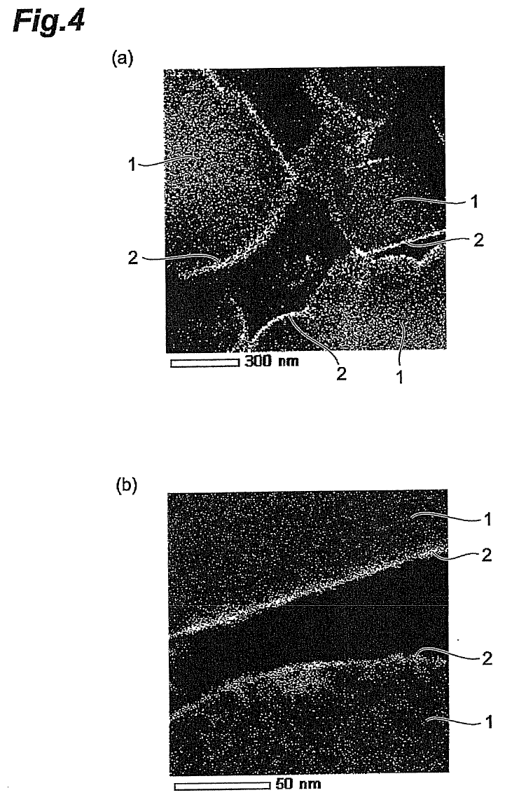

The treatment solution temperature was set to 40° C., the reaction time was set to 1 hour, and heat treatment in an open-air atmosphere at 500° C. was carried out. Aside from the above, the same procedure was carried out as in Example 7. The weight ratio of ZrO₂ was 0.69 wt %, the average particle diameter was 10 nm, and the adhesive force was 2.0 μN. The discharge capacity after 300 cycles was 95% of the initial discharge capacity. EDS mapping images of the positive electrode active material obtained are shown in (a) and (b) of FIG. 4. Regions denoted by the reference symbol 1 indicate the LiNi_{1/3}Mn_{1/3}Co_{1/3}O₂ serving as the first metal oxide, and regions denoted by the reference symbol 2 indicate ZrO₂ particles. The ZrO₂ particles are coated on the surface of the first metal oxide 1 in an essentially layer-like manner.

### EXAMPLE 15-2

Heat treatment in an open-air atmosphere was carried out at 600° C. Aside from the above, the same procedure was carried out as in Example 15. The weight ratio of ZrO₂ was 0.69 wt %, the average particle diameter was 25 nm, and the adhesive force was 1.3 μN. The discharge capacity after 300 cycles was 95% of the initial discharge capacity.

### EXAMPLE 16

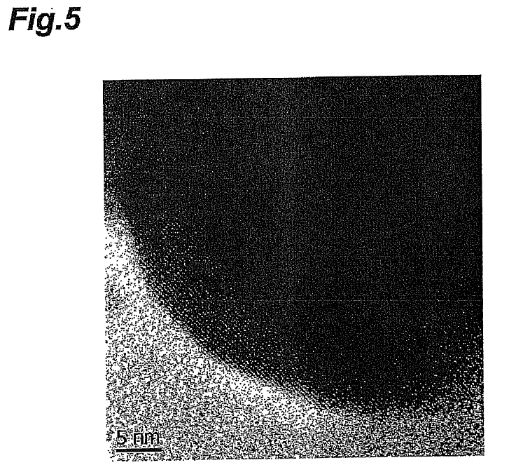

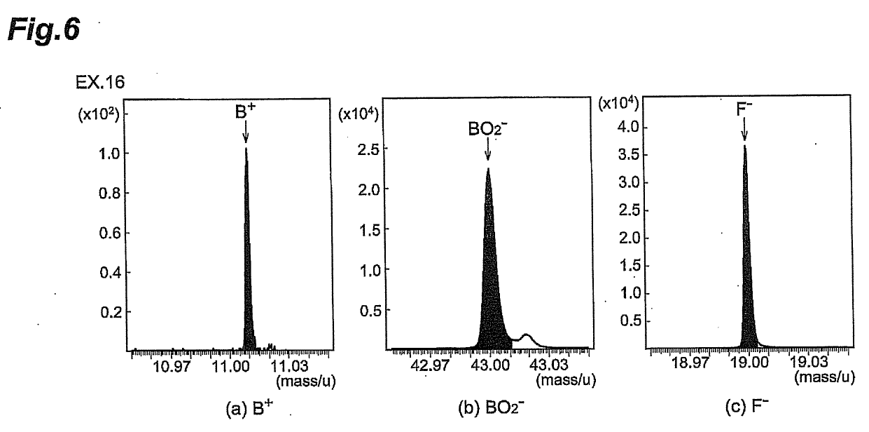

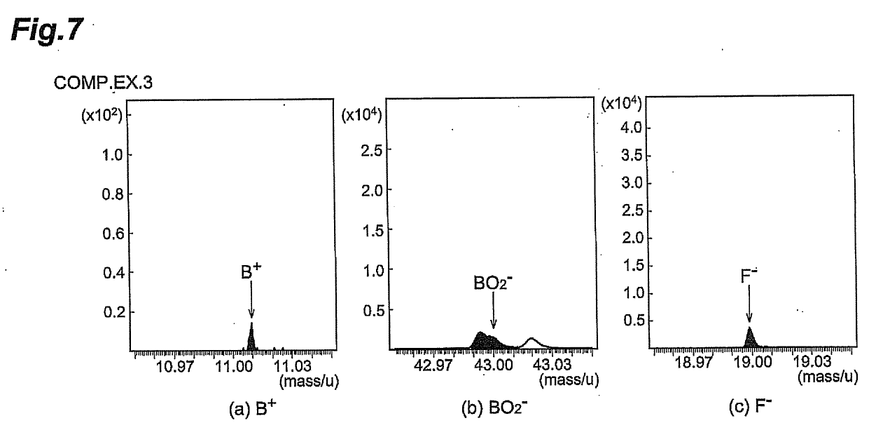

The treatment solution temperature was set to 40° C., and the reaction time was set to 3 hours. Aside from the above, the same procedure was carried out as in Example 7. A high-resolution transmission electron microscope (TEM) image of the ZrO₂ particles serving as the second metal oxide particles is shown in FIG. 5. As is apparent from FIG. 5, many single-crystal ZrO₂ particles were observed. The weight ratio of ZrO₂ was 0.75 wt %, and the average particle size was 50 nm. This active material was analyzed by time-of-flight secondary ion mass spectroscopy (TOF-SIMS) using a TOF-SIMS-5 spectrometer (manufactured by ION-TOF). Analysis was carried out using Bi³⁺ as the primary ion species over an area of analysis measuring 200 μm×200 μm. As a result, in addition to secondary ions thought to originate from the first metal oxide LiNi_{1/3}Mn_{1/3}Co_{1/3}O₂ and the attached ZrO₂ particles, F⁻, BO₂⁻ and B⁺ were also detected from the surface of the active material. TOF-SIMS spectra of the active material prepared in Example 16 are shown in (a), (b) and (c) of FIG. 6, and TOF-SIMS spectra of the active material prepared in Comparative Example 3 (this active material is described subsequently in detail, but does not have particles of the second metal oxide formed therein) are shown in (a), (b) and (c) of FIG. 7. As is apparent from these spectra, the levels of F⁻, BO₂⁻ and B⁺ were clearly higher in Example 16 than in Comparative Example 3. In other words, it is apparent that, owing to LPD treatment, the chemical species detected as F⁻, BO₂⁻ and B⁺ are present as secondary ion species on the active material surface at the time of TOF-SIMS analysis.

In addition, a depth direction analysis of Zr⁺, F⁻, BO₂⁻ and B⁺ was carried out by TOF-SIMS. Analysis was carried out under the following conditions: primary ion species, Bi³⁺; area of analysis, 100 μm×100 μm. The sputtering conditions were as follows: sputtering ions, C₆₀⁺⁺; sputtering region, 300 μm×300 μm. As a result, the chemical species that appear as the secondary ion species Zr⁺, F⁻, BO₂⁻ and B⁺ were each found to be present to a depth of 20 nm from the surface of the active material.

Given that, based on the results of TEM observation, the ZrO₂ particles had an average particle size of 50 nm and the height from the surface of the first metal oxide was about 25 nm, the measurement results obtained from TOF-SIMS depth-direction analysis which indicate the presence of Zr⁺ to a depth of 20 nm from the active material surface appear to be entirely reasonable. Moreover, as noted above, because the average particle size of the ZrO₂ particles (second metal oxide particles) is the diameter in the direction along the surface of the particles of the first metal oxide, and the ZrO₂ particles are attached to the first metal oxide particles in much the same manner as plates set on a table, the thickness of the first metal oxide is about one-half the diameter. In addition, judging from the results obtained that F⁻, BO₂⁻ and B⁺ too, as with Zr⁺, are present to a depth of 20 nm from the surface of the active material, it appears that F⁻, BO⁻² and B⁺ are not present at the interior of the first metal oxide, but rather are present together with Zr⁺ within the second metal oxide particles.

Based on the results of ion chromatographic analysis, the content of F⁻ in the active material as a whole was 240 ppm. Based on the results of ICP analysis, the content of boron was 30 weight ppm. The adhesive force of ZrO₂ was 1.4 μN. The discharge capacity after 300 cycles was 94% of the initial discharge capacity.

### EXAMPLE 16-2

Heat treatment in an open-air atmosphere was carried out at 500° C. Aside from the above, the same procedure was carried out as in Example 16. The weight ratio of ZrO₂ particles was 0.75 wt %, the average particle diameter was 10 nm, and the adhesive force was 1.0 μN. The discharge capacity after 300 cycles was 91% of the initial discharge capacity.

### EXAMPLE 16-3

Heat treatment in an open-air atmosphere was carried out at 600° C. Aside from the above, the same procedure was carried out as in Example 16. The weight ratio of ZrO₂ particles was 0.75 wt %, the average particle diameter was 25 nm, and the adhesive force was 1.5 μN. The discharge capacity after 300 cycles was 92% of the initial discharge capacity.

### EXAMPLE 16-4

Heat treatment in an open-air atmosphere was carried out at 800° C. Aside from the above, the same procedure was carried out as in Example 16. The weight ratio of ZrO₂ particles was 0.75 wt %, the average particle diameter was 75 nm, and the adhesive force was 2.0 μN. The discharge capacity after 300 cycles was 94% of the initial discharge capacity.

### EXAMPLE 16-5

Heat treatment in an open-air atmosphere was carried out at 900° C. Aside from the above, the same procedure was carried out as in Example 16. The weight ratio of ZrO₂ particles was 0.75 wt %, the average particle diameter was 100 nm, and the adhesive force was 1.6 μN. The discharge capacity after 300 cycles was 93% of the initial discharge capacity.

### EXAMPLE 17

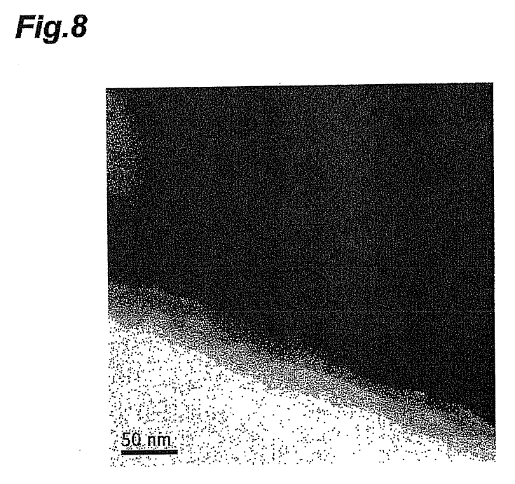

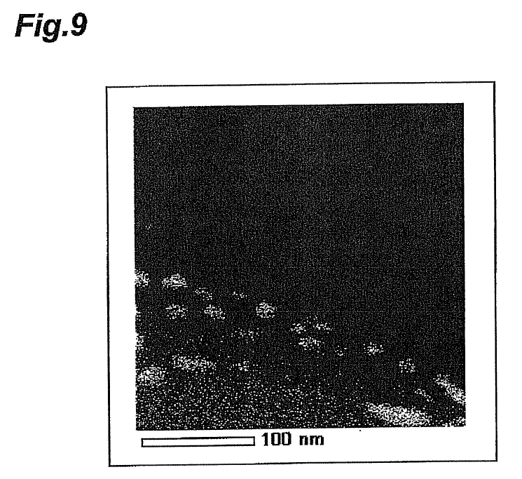

The treatment solution temperature was set to 40° C., and the reaction time was set to 24 hours. Aside from the above, the same procedure was carried out as in Example 7. The weight ratio of ZrO₂ was 0.78 wt %, the average particle diameter was 15 nm, and the adhesive force was 2.0 μN. A STEM micrograph and an EDS (energy dispersive x-ray spectroscopy) mapping image are shown in FIGS. 8 and 9, respectively. The discharge capacity after 300 cycles was 95% of the initial discharge capacity.

### EXAMPLE 18

The treatment solution temperature was set to 50° C., and the reaction time was set to 10 minutes. Aside from the above, the same procedure was carried out as in Example 7. The weight ratio of ZrO₂ was 0.69 wt %, the average particle diameter was 3 nm, and the adhesive force was 1.3 μN. The discharge capacity after 300 cycles was 94% of the initial discharge capacity.

### EXAMPLE 19

The treatment solution temperature was set to 50° C., and the reaction time was set to 20 minutes. Aside from the above, the same procedure was carried out as in Example 7. The weight ratio of ZrO₂ was 0.73 wt %, the average particle diameter was 5 nm, and the adhesive force was 1.0 μN. The discharge capacity after 300 cycles was 94% of the initial discharge capacity.

### EXAMPLE 20

The treatment solution temperature was set to 50° C., and the reaction time was set to 1 hour. Aside from the above, the same procedure was carried out as in Example 7. The weight ratio of ZrO₂ was 0.75 wt %, the average particle diameter was 8 nm, and the adhesive force was 2.0 μN. The discharge capacity after 300 cycles was 93% of the initial discharge capacity.

### EXAMPLE 21

The treatment solution temperature was set to 50° C., and the reaction time was set to 3 hours. Aside from the above, the same procedure was carried out as in Example 7. The weight ratio of ZrO₂ was 0.80 wt %, the average particle diameter was 10 nm, and the adhesive force was 1.4 μN. The discharge capacity after 300 cycles was 90% of the initial discharge capacity.

### EXAMPLE 22

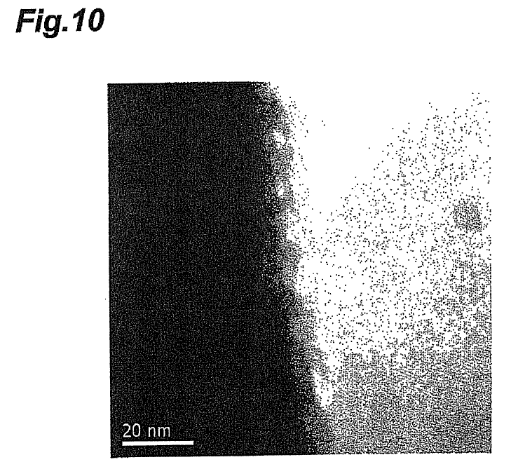

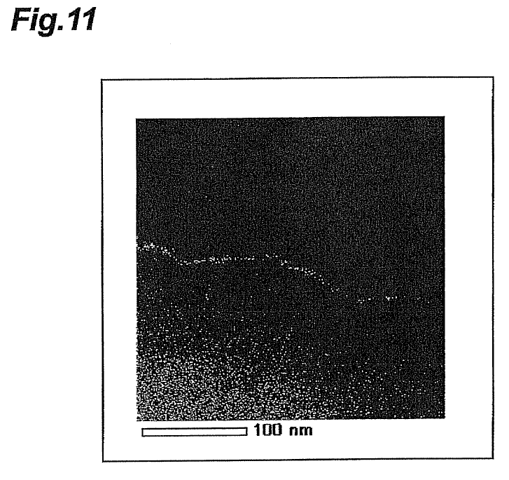

The treatment solution temperature was set to 50° C., and the reaction time was set to 24 hours. Aside from the above, the same procedure was carried out as in Example 7. The weight ratio of ZrO₂ was 0.82 wt %, the average particle diameter was 13 nm, and the adhesive force was 0.7 μN. A STEM micrograph and an EDS (energy dispersive x-ray spectroscopy) mapping image are shown in FIGS. 10 and 11, respectively.

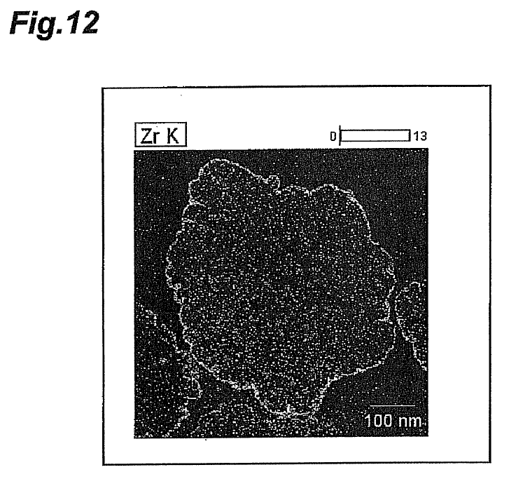

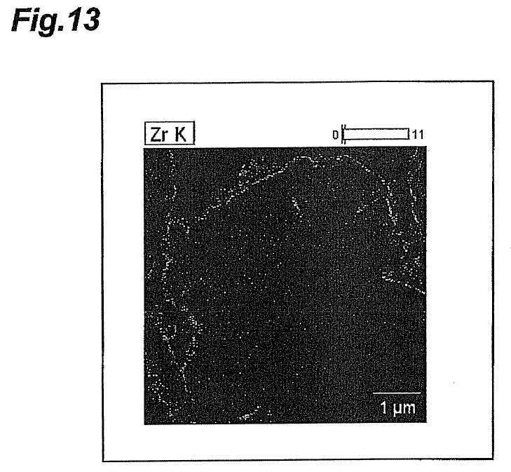

FIG. 10 shows a STEM micrograph of this active material, FIGS. 11 and 12 show EDS mapping images of the active material, and FIG. 13 shows a STEM micrograph of an electrode in which the active material was used. In FIG. 10, numerous ZrO₂ particles 20 nm or smaller can be seen to be attached to the surface of a particle of the first metal oxide. From FIGS. 11 and 12, the ZrO₂ particles appear to be layer-like. It is particularly apparent from FIG. 12 that the entire particle of the first metal oxide is coated with ZrO₂ particles. This manner of adhesion has been unattainable in the prior art. During the process of electrode formation, the coated particles of the first metal oxide are subjected to stresses from mixing, kneading and the application of pressure, giving rise to concerns over the shedding of ZrO₂ particles from particles of the first metal oxide. However, it is apparent from FIG. 13 that the particles of the first metal oxide remain coated with ZrO₂ particles even after electrode formation. Hence, in the present invention, the particles of the second metal oxide have a large adhesive force to the particles of the first metal oxide. In the prior art, it has not been possible to achieve such an adhesive force. The discharge capacity after 300 cycles was 93% of the initial discharge capacity.

### EXAMPLE 23

The treatment solution temperature was set to 60° C., and the reaction time was set to 10 minutes. Aside from the above, the same procedure was carried out as in Example 7. The weight ratio of ZrO₂ was 0.74 wt %, the average particle diameter was 1 nm, and the adhesive force was 1.6 μN. The discharge capacity after 300 cycles was 94% of the initial discharge capacity.

### EXAMPLE 24

The treatment solution temperature was set to 60° C., and the reaction time was set to 20 minutes. Aside from the above, the same procedure was carried out as in Example 7. The weight ratio of ZrO₂ was 0.75 wt %, the average particle diameter was 3 nm, and the adhesive force was 3.0 μN. The discharge capacity after 300 cycles was 93% of the initial discharge capacity.

### EXAMPLE 25

The treatment solution temperature was set to 60° C., and the reaction time was set to 1 hour. Aside from the above, the same procedure was carried out as in Example 7. The weight ratio of ZrO₂ was 0.78 wt %, the average particle diameter was 5 nm, and the adhesive force was 5.0 μN. The discharge capacity after 300 cycles was 96% of the initial discharge capacity.

### EXAMPLE 26

The treatment solution temperature was set to 60° C., and the reaction time was set to 3 hours. Aside from the above, the same procedure was carried out as in Example 7. The weight ratio of ZrO₂ was 0.82 wt %, the average particle diameter was 8 nm, and the adhesive force was 10.0 μN. The discharge capacity after 300 cycles was 92% of the initial discharge capacity.

### EXAMPLE 27

The treatment solution temperature was set to 60° C., and the reaction time was set to 24 hours. Aside from the above, the same procedure was carried out as in Example 7. The weight ratio of ZrO₂ was 0.82 wt %, the average particle diameter was 10 nm, and the adhesive force was 2.0 μN. The discharge capacity after 300 cycles was 90% of the initial discharge capacity.

### EXAMPLE 28

The concentrations of K₂ZrF₆ and H₃BO₃ in the LPD treatment solution were adjusted to 0.001 M and 0.005 M, respectively. The treatment solution temperature was set to 40° C., and the reaction time was set to 10 minutes. Aside from the above, the same procedure was carried out as in Example 7. The weight ratio of ZrO₂ was 0.068 wt %, the average particle diameter was 1 nm, and the adhesive force was 0.5 μN. The discharge capacity after 300 cycles was 96% of the initial discharge capacity.

### EXAMPLE 29

The concentrations of K₂ZrF₆ and H₃BO₃ in the LPD treatment solution were adjusted to 0.001 M and 0.005 M, respectively. The treatment solution temperature was set to 40° C., and the reaction time was set to 20 minutes. Aside from the above, the same procedure was carried out as in Example 7. The weight ratio of ZrO₂ was 0.070 wt %, the average particle diameter was 2 nm, and the adhesive force was 0.6 μN. The discharge capacity after 300 cycles was 95% of the initial discharge capacity.

### EXAMPLE 30

The concentrations of K₂ZrF₆ and H₃BO₃ in the LPD treatment solution were adjusted to 0.001 M and 0.005 M, respectively. The treatment solution temperature was set to 40° C., and the reaction time was set to 1 hour. Aside from the above, the same procedure was carried out as in Example 7. The weight ratio of ZrO₂ was 0.074 wt %, the average particle diameter was 6 nm, and the adhesive force was 0.6 μN. The discharge capacity after 300 cycles was 94% of the initial discharge capacity.

### EXAMPLE 31

The concentrations of K₂ZrF₆ and H₃BO₃ in the LPD treatment solution were adjusted to 0.001 M and 0.005 M, respectively. The treatment solution temperature was set to 40° C., and the reaction time was set to 3 hours. Aside from the above, the same procedure was carried out as in Example 7. The weight ratio of ZrO₂ was 0.080 wt %, the average particle diameter was 9 nm, and the adhesive force was 0.5 μN. The discharge capacity after 300 cycles was 92% of the initial discharge capacity.

### EXAMPLE 32

The concentrations of K₂ZrF₆ and H₃BO₃ in the LPD treatment solution were adjusted to 0.001 M and 0.005 M, respectively. The treatment solution temperature was set to 40° C., and the reaction time was set to 24 hours. Aside from the above, the same procedure was carried out as in Example 7. The weight ratio of ZrO₂ was 0.082 wt %, the average particle diameter was 15 nm, and the adhesive force was 0.6 μN. The discharge capacity after 300 cycles was 94% of the initial discharge capacity.

### EXAMPLE 33

The concentrations of K₂ZrF₆ and H₃BO₃ in the LPD treatment solution were adjusted to 0.0001 M and 0.0005 M, respectively. The treatment solution temperature was set to 40° C., and the reaction time was set to 10 minutes. Aside from the above, the same procedure was carried out as in Example 7. The weight ratio of ZrO₂ was 0.0071 wt %, the average particle diameter was 1 nm, and the adhesive force was 0.1 μN. The discharge capacity after 300 cycles was 80% of the initial discharge capacity.

### EXAMPLE 34

The concentrations of K₂ZrF₆ and H₃BO₃ in the LPD treatment solution were adjusted to 0.0001 M and 0.0005 M, respectively. The treatment solution temperature was set to 40° C., and the reaction time was set to 20 minutes. Aside from the above, the same procedure was carried out as in Example 7. The weight ratio of ZrO₂ was 0.0073 wt %, the average particle diameter was 1 nm, and the adhesive force was 0.1 μN. The discharge capacity after 300 cycles was 79% of the initial discharge capacity.

### EXAMPLE 35

The concentrations of K₂ZrF₆ and H₃BO₃ in the LPD treatment solution were adjusted to 0.0001 M and 0.0005 M, respectively. The treatment solution temperature was set to 40° C., and the reaction time was set to 1 hour. Aside from the above, the same procedure was carried out as in Example 7. The weight ratio of ZrO₂ was 0.0076 wt %, the average particle diameter was 2 nm, and the adhesive force was 0.1 μN. The discharge capacity after 300 cycles was 78% of the initial discharge capacity.

### EXAMPLE 36

The concentrations of K₂ZrF₆ and H₃BO₃ in the LPD treatment solution were adjusted to 0.0001 M and 0.0005 M, respectively. The treatment solution temperature was set to 40° C., and the reaction time was set to 3 hours. Aside from the above, the same procedure was carried out as in Example 7. The weight ratio of ZrO₂ was 0.0082 wt %, the average particle diameter was 2 nm, and the adhesive force was 0.1 μN. The discharge capacity after 300 cycles was 78% of the initial discharge capacity.

### EXAMPLE 37

The concentrations of K₂ZrF₆ and H₃BO₃ in the LPD treatment solution were adjusted to 0.0001 M and 0.0005 M, respectively. The treatment solution temperature was set to 40° C., and the reaction time was set to 24 hours. Aside from the above, the same procedure was carried out as in Example 7. The weight ratio of ZrO₂ was 0.0082 wt %, the average particle diameter was 2 nm, and the adhesive force was 0.1 μN. The discharge capacity after 300 cycles was 80% of the initial discharge capacity.

### EXAMPLE 38

The metal-fluoro complex was changed to (NH₄)₂SiF₆. The concentrations of (NH₄)₂SiF₆ and H₃BO₃ were adjusted to 0.01 M and 0.05 M, respectively. The treatment solution temperature was set to 40° C., and the reaction time was set to 24 hours. Aside from the above, the same procedure was carried out as in Example 7. The weight ratio of SiO₂ was 0.24 wt %, the average particle diameter was 15 nm, and the adhesive force was 1.5 μN. The discharge capacity after 300 cycles was 90% of the initial discharge capacity.

### EXAMPLE 39

The first metal oxide was changed to LiNi_{0.80}Co_{0.15}Al_{0.05}O₂. The reaction time was set to 1 hour. Aside from the above, the same procedure was carried out as in Example 1. The weight ratio of ZrO₂ particles was 0.79 wt %, the average particle diameter was 50 nm, and the adhesive force was 1.3 μN. The discharge capacity after 300 cycles was 93% of the initial discharge capacity.

### EXAMPLE 40

The reaction time was set to 3 hours. Aside from the above, the same procedure was carried out as in Example 39. The weight ratio of ZrO₂ particles was 0.82 wt %, the average particle diameter was 60 nm, and the adhesive force was 1.3 μN. The discharge capacity after 300 cycles was 94% of the initial discharge capacity.

### EXAMPLE 41

The LPD treatment solution was adjusted to a K₂ZrF₆ concentration of 0.01 M, and H₃BO₃ was not added. The reaction time was set to 3 hours. Aside from the above, the same procedure was carried out as in Example 39. The weight ratio of ZrO₂ particles was 0.81 wt %, the average particle diameter was 60 nm, and the adhesive force was 2.0 μN. The discharge capacity after 300 cycles was 96% of the initial discharge capacity.

### COMPARATIVE EXAMPLE 3

Aside from using the first metal oxide Li_{1/3}Mi_{1/3}Co_{1/3}O₂ which was not coated with particles of the second metal oxide, the same procedure was carried out as in Example 7. The discharge capacity after 300 cycles was 69% of the initial discharge capacity.

### COMPARATIVE EXAMPLE 12

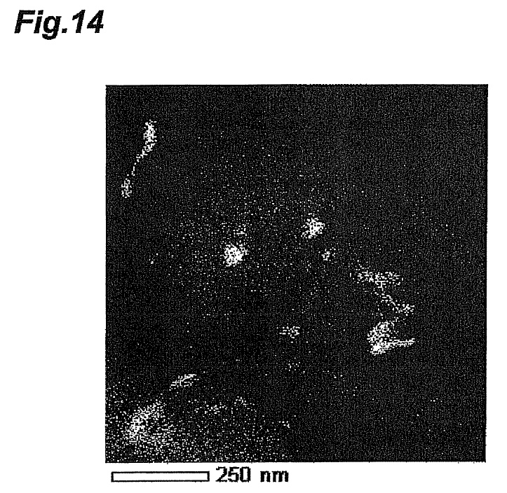

Aside from employing a method that uses an alkoxide compound as the method for depositing ZrO₂ as the second metal oxide onto LiNi_{1/3}Mn_{1/3}Co_{1/3}O₂ as the first metal oxide, the same procedure was carried out as in Example 7. Tetraethoxyzirconium (Zr(OC₂H₅)₄) was dissolved in ethyl alcohol to a concentration of 0.01 M. Next, 120 g of LiNi_{1/3}Mn_{1/3}Co_{1/3}O₂ was added to 800 ml of this solution under stirring. The resulting dispersion was stirred while being warmed at 60° C. Once the ethyl alcohol had evaporated, the LiNi_{1/3}Mn_{1/3}Co_{1/3}O₂ was heat-treated in an open-air atmosphere at 700° C. for 2 hours. It is apparent from FIG. 14 that ZrO₂ was attached to the surface of the active material. The ZrO₂ was attached in some places but not attached in other places, and thus was unevenly distributed on the surface of the active material. The weight ratio of ZrO₂ was 0.32 wt %, the average particle diameter was 100 nm, and the adhesive force was 0.01 μN. The discharge capacity after 300 cycles was 71% of the initial discharge capacity.

### COMPARATIVE EXAMPLE 13

Aside from using LiMn₂O₄ as the first metal oxide, the same procedure was carried out as in Comparative Example 12. The weight ratio of ZrO₂ was 0.32 wt %, the average particle diameter was 100 nm, and the adhesive force was 0.03 μN. The discharge capacity after 300 cycles was 58% of the initial discharge capacity.

### COMPARATIVE EXAMPLE 14

Aside from using LiMn_{1.9}Al_{0.1}O₄ as the first metal oxide, the same procedure was carried out as in Comparative Example 13. The weight ratio of ZrO₂ was 0.32 wt %, the average particle diameter was 100 nm, and the adhesive force was 0.04 μN. The discharge capacity after 300 cycles was 63% of the initial discharge capacity.

Table 2 shows the conditions and results for Examples 1 to 18 of the invention, Table 3 shows the conditions and results for Examples 19 to 37 of the invention, Table 4 shows the conditions and results for Example 38 of the invention, Table 5 shows the conditions and results for Comparative Examples 1 to 3, and Table 6 shows the conditions and results for Comparative Examples 12 to 14. In the examples where an LPD treatment solution was used, the corresponding table also shows the pH of the filtrate solution.

TABLE 2

| | | | | | | ACTIVE | HEAT |
|---|---|---|---|---|---|---|---|
| | POSITIVE | REACTION | REACTION | | | MATERIAL | TREATMENT |
| | ELECTRODE | TIME | TEMPERATURE | K₂ZrF₈ | H₃BO₃ | WEIGHT | TEMPERATURE |
| | ACTIVE MATERIAL | (h) | (° C.) | (M) | (M) | (g) | (° C.) |
| EX. 1 | LiMn₂O₄ | 24 | 40 | 0.01 | 0.05 | 120 | 700 |
| EX. 2 | LiMn₂O₄ | 24 | 40 | 0.04 | 0.20 | 120 | 700 |
| EX. 3 | LiMn₂O₄ | 0.33 | 40 | 0.005 | 0.025 | 120 | 700 |
| EX. 4 | LiMn₂O₄ | 24 | 40 | 0.06 | 0.30 | 120 | 700 |
| EX. 5 | LiMn₂O₄ | 48 | 40 | 0.06 | 0.30 | 120 | 700 |
| EX. 6 | LiMn_{1.8}Al_{0.1}O₄ | 3.0 | 40 | 0.04 | 0.20 | 120 | 700 |
| EX. 7 | LiNi_{1/8}Mn_{1/3}Co_{1/3}O₂ | 0.17 | 30 | 0.01 | 0.05 | 120 | 700 |
| EX. 8 | LiNi_{1/8}Mn_{1/3}Co_{1/3}O₂ | 0.33 | 30 | 0.01 | 0.05 | 120 | 700 |
| EX. 9 | LiNi_{1/3}Mn_{1/3}Co_{1/3}O₂ | 1 | 30 | 0.01 | 0.05 | 120 | 700 |
| EX. 10 | LiNi_{1/3}Mn_{1/3}Co_{1/3}O₂ | 3 | 30 | 0.01 | 0.05 | 120 | 700 |
| EX. 11 | LiNi_{1/3}Mn_{1/3}Co_{1/3}O₂ | 24 | 30 | 0.01 | 0.05 | 120 | 700 |
| EX. 12 | LiNi_{1/3}Mn_{1/3}Co_{1/3}O₂ | 0.17 | 40 | 0.01 | 0.05 | 120 | 700 |
| EX. 13 | LiNi_{1/3}Mn_{1/3}Co_{1/3}O₂ | 0.33 | 40 | 0.01 | 0.05 | 120 | 700 |
| EX. 14 | LiNi_{1/3}Mn_{1/3}Co_{1/3}O₂ | 1 | 40 | 0.01 | 0.05 | 120 | 700 |
| EX. 15 | LiNi_{1/3}Mn_{1/3}Co_{1/3}O₂ | 1 | 40 | 0.01 | 0.05 | 120 | 500 |
| EX. 15-2 | LiNi_{1/3}Mn_{1/3}Co_{1/3}O₂ | 1 | 40 | 0.01 | 0.05 | 120 | 600 |
| EX. 16 | LiNi_{1/3}Mn_{1/3}Co_{1/3}O₂ | 3 | 40 | 0.01 | 0.05 | 120 | 700 |
| EX. 16-2 | LiNi_{1/3}Mn_{1/3}Co_{1/3}O₂ | 3 | 40 | 0.01 | 0.05 | 120 | 500 |
| EX. 16-3 | LiNi_{1/3}Mn_{1/3}Co_{1/3}O₂ | 3 | 40 | 0.01 | 0.05 | 120 | 600 |
| EX. 16-4 | LiNi_{1/3}Mn_{1/3}Co_{1/3}O₂ | 3 | 40 | 0.01 | 0.05 | 120 | 800 |
| EX. 16-5 | LiNi_{1/3}Mn_{1/3}Co_{1/3}O₂ | 3 | 40 | 0.01 | 0.05 | 120 | 900 |
| EX. 17 | LiNi_{1/3}Mn_{1/3}Co_{1/3}O₂ | 24 | 40 | 0.01 | 0.05 | 120 | 700 |
| EX. 18 | LiNi_{1/3}Mn_{1/3}Co_{1/3}O₂ | 0.17 | 50 | 0.01 | 0.05 | 120 | 700 |

| | HEAT | ZrO₂ AVERAGE | | CAPACITY | | |
|---|---|---|---|---|---|---|
| | TREATMENT | PARTICLE | | RATIO AFTER | ADHESIVE | |
| | TIME | DIAMETER | ZrO₂ | 300 CYCLES | FORCE | |
| | (h) | (nm) | (wt %) | (%) | (μN) | pH |
| EX. 1 | 2 | 20 | 0.20 | 70 | 1.3 | 5.9 |
| EX. 2 | 2 | 40 | 0.51 | 75 | 1.5 | 5.6 |
| EX. 3 | 2 | 20 | 0.07 | 65 | 1.0 | 5.3 |
| EX. 4 | 2 | 40 | 0.81 | 80 | 2.0 | 5.1 |
| EX. 5 | 2 | 40 | 1.13 | 85 | 1.0 | 5.1 |
| EX. 6 | 2 | 20 | 0.62 | 77 | 2.0 | 5.5 |
| EX. 7 | 2 | 20 | 0.53 | 93 | 2.0 | 7.4 |
| EX. 8 | 2 | 75 | 0.59 | 94 | 1.0 | 7.4 |
| EX. 9 | 2 | 90 | 0.66 | 79 | 0.3 | 7.4 |
| EX. 10 | 2 | 50 | 0.73 | 80 | 0.1 | 7.6 |
| EX. 11 | 2 | 200 | 0.76 | 76 | 0.1 | 7.9 |
| EX. 12 | 2 | 5 | 0.59 | 94 | 1.3 | 7.5 |
| EX. 13 | 2 | 70 | 0.63 | 91 | 1.5 | 7.5 |
| EX. 14 | 2 | 70 | 0.69 | 93 | 2.0 | 7.5 |
| EX. 15 | 2 | 10 | 0.69 | 95 | 2.0 | 7.5 |
| EX. 15-2 | 2 | 25 | 0.69 | 95 | 1.3 | 7.5 |
| EX. 16 | 2 | 50 | 0.75 | 94 | 1.4 | 7.7 |
| EX. 16-2 | 2 | 10 | 0.75 | 91 | 1.0 | 7.7 |
| EX. 16-3 | 2 | 25 | 0.75 | 92 | 1.5 | 7.7 |
| EX. 16-4 | 2 | 75 | 0.75 | 94 | 2.0 | 7.7 |
| EX. 16-5 | 2 | 100 | 0.75 | 93 | 1.6 | 7.7 |
| EX. 17 | 2 | 15 | 0.78 | 95 | 2.0 | 8.0 |
| EX. 18 | 2 | 3 | 0.69 | 94 | 1.3 | 7.6 |

TABLE 3

| | | | | | | ACTIVE | HEAT |
|---|---|---|---|---|---|---|---|
| | POSITIVE | REACTION | REACTION | | | MATERIAL | TREATMENT |
| | ELECTRODE | TIME | TEMPERATURE | K₂ZrF₈ | H₃BO₃ | WEIGHT | TEMPERATURE |
| | ACTIVE MATERIAL | (h) | (° C.) | (M) | (M) | (g) | (° C.) |
| EX. 19 | LiNi_{1/3}Mn_{1/3}Co_{1/3}O₂ | 0.33 | 50 | 0.01 | 0.05 | 120 | 700 |
| EX. 20 | LiNi_{1/3}Mn_{1/3}Co_{1/3}O₂ | 1 | 50 | 0.01 | 0.05 | 120 | 700 |
| EX. 21 | LiNi_{1/3}Mn_{1/3}Co_{1/3}O₂ | 3 | 50 | 0.01 | 0.05 | 120 | 700 |
| EX. 22 | LiNi_{1/3}Mn_{1/3}Co_{1/3}O₂ | 24 | 50 | 0.01 | 0.05 | 120 | 700 |
| EX. 23 | LiNi_{1/3}Mn_{1/3}Co_{1/3}O₂ | 0.17 | 60 | 0.01 | 0.05 | 120 | 700 |
| EX. 24 | LiNi_{1/3}Mn_{1/3}Co_{1/3}O₂ | 0.33 | 60 | 0.01 | 0.05 | 120 | 700 |
| EX. 25 | LiNi_{1/3}Mn_{1/3}Co_{1/3}O₂ | 1 | 80 | 0.01 | 0.05 | 120 | 700 |
| EX. 26 | LiNi_{1/3}Mn_{1/3}Co_{1/3}O₂ | 3 | 60 | 0.01 | 0.05 | 120 | 700 |
| EX. 27 | LiNi_{1/3}Mn_{1/3}Co_{1/3}O₂ | 24 | 60 | 0.01 | 0.05 | 120 | 700 |
| EX. 28 | LiNi_{1/3}Mn_{1/3}Co_{1/3}O₂ | 0.17 | 40 | 0.001 | 0.005 | 120 | 700 |
| EX. 29 | LiNi_{1/3}Mn_{1/3}Co_{1/3}O₂ | 0.33 | 40 | 0.001 | 0.005 | 120 | 700 |
| EX. 30 | LiNi_{1/3}Mn_{1/3}Co_{1/3}O₂ | 1 | 40 | 0.001 | 0.005 | 120 | 700 |
| EX. 31 | LiNi_{1/3}Mn_{1/3}Co_{1/3}O₂ | 3 | 40 | 0.001 | 0.005 | 120 | 700 |
| EX. 32 | LiNi_{1/3}Mn_{1/3}Co_{1/3}O₂ | 24 | 40 | 0.001 | 0.005 | 120 | 700 |
| EX. 33 | LiNi_{1/3}Mn_{1/3}Co_{1/3}O₂ | 0.17 | 40 | 0.0001 | 0.0005 | 120 | 700 |
| EX. 34 | LiNi_{1/3}Mn_{1/3}Co_{1/3}O₂ | 0.33 | 40 | 0.0001 | 0.0005 | 120 | 700 |
| EX. 35 | LiNi_{1/3}Mn_{1/3}Co_{1/3}O₂ | 1 | 40 | 0.0001 | 0.0005 | 120 | 700 |
| EX. 36 | LiNi_{1/3}Mn_{1/3}Co_{1/3}O₂ | 3 | 40 | 0.0001 | 0.0005 | 120 | 700 |
| EX. 37 | LiNi_{1/3}Mn_{1/3}Co_{1/3}O₂ | 24 | 40 | 0.0001 | 0.0005 | 120 | 700 |
| EX. 39 | LiNi_{0.80}Co_{0.15}Al_{0.05}O₂ | 1 | 40 | 0.01 | 0.05 | 120 | 700 |
| EX. 40 | LiNi_{0.80}Co_{0.15}Al_{0.05}O₂ | 3 | 40 | 0.01 | 0.05 | 120 | 700 |
| EX. 41 | LiNi_{0.80}Co_{0.15}Al_{0.05}O₂ | 3 | 40 | 0.01 | NONE | 120 | 700 |

| | HEAT | ZrO₄ AVERAGE | | CAPACITY | | |
|---|---|---|---|---|---|---|
| | TREATMENT | PARTICLE | | RATIO AFTER | ADHESIVE | |
| | TIME | DIAMETER | ZrO₄ | 300 CYCLES | FORCE | |
| | (h) | (nm) | (wt %) | (%) | (μN) | pH |
| EX. 19 | 2 | 5 | 0.73 | 94 | 1.0 | 7.6 |
| EX. 20 | 2 | 8 | 0.75 | 93 | 2.0 | 7.6 |
| EX. 21 | 2 | 10 | 0.80 | 90 | 1.4 | 7.8 |
| EX. 22 | 2 | 13 | 0.82 | 93 | 0.7 | 8.1 |
| EX. 23 | 2 | 1 | 0.74 | 94 | 1.6 | 7.7 |
| EX. 24 | 2 | 3 | 0.75 | 93 | 3.0 | 7.7 |
| EX. 25 | 2 | 5 | 0.78 | 96 | 5.0 | 7.7 |
| EX. 26 | 2 | 8 | 0.82 | 92 | 10.0 | 7.9 |
| EX. 27 | 2 | 10 | 0.82 | 90 | 2.0 | 8.2 |
| EX. 28 | 2 | 1 | 0.068 | 96 | 0.5 | 9.0 |
| EX. 29 | 2 | 2 | 0.070 | 95 | 0.6 | 9.0 |
| EX. 30 | 2 | 6 | 0.074 | 94 | 0.6 | 9.0 |
| EX. 31 | 2 | 9 | 0.080 | 92 | 0.5 | 9.2 |
| EX. 32 | 2 | 15 | 0.082 | 94 | 0.6 | 9.5 |
| EX. 33 | 2 | 1 | 0.0071 | 80 | 0.1 | 9.5 |
| EX. 34 | 2 | 1 | 0.0073 | 79 | 0.1 | 9.5 |
| EX. 35 | 2 | 2 | 0.0076 | 78 | 0.1 | 9.5 |
| EX. 36 | 2 | 2 | 0.0082 | 78 | 0.1 | 9.7 |
| EX. 37 | 2 | 2 | 0.0082 | 80 | 0.1 | 9.9 |
| EX. 39 | 2 | 50 | 0.79 | 93 | 1.3 | 10.2 |
| EX. 40 | 2 | 60 | 0.82 | 94 | 1.3 | 11.5 |
| EX. 41 | 2 | 60 | 0.81 | 96 | 2 | 11.9 |

TABLE 4

| | POSITIVE | | | | | ACTIVE | HEAT |
|---|---|---|---|---|---|---|---|
| | ELECTRODE | REACTION | REACTION | | | MATERIAL | TREATMENT |
| | ACTIVE | TIME | TEMPERATURE | (NH₄)₂SiF₈ | H₃BO₃ | WEIGHT | TEMPERATURE |
| | MATERIAL | (h) | (° C.) | (M) | (M) | (g) | (° C.) |
| EX. 38 | LiNi_{1/3}Mn_{1/3}Co_{1/3}O₂ | 24 | 40 | 0.01 | 0.05 | 120 | 700 |

| | HEAT | SiO₂ AVERAGE | | CAPACITY | | |
|---|---|---|---|---|---|---|
| | TREATMENT | PARTICLE | | RATIO AFTER | ADHESIVE | |
| | TIME | DIAMETER | SiO₂ | 300 CYCLES | FORCE | |
| | (h) | (nm) | (wt %) | (%) | (μN) | pH |
| EX. 38 | 2 | 15 | 0.24 | 90 | 1.5 | 8.1 |

TABLE 5

| | | ZrO₂ AVERAGE | | CAPACITY | |
|---|---|---|---|---|---|
| | POSITIVE | PARTICLE | | RATIO AFTER | ADHESIVE |
| | ELECTRODE | DIAMETER | ZrO₂ | 300 CYCLES | FORCE |
| | ACTIVE MATERIAL | (nm) | (wt %) | (%) | (μN) |
| COMP. EX. 1 | LiMn₂O₄ | — | — | 50 | — |
| COMP. EX. 2 | LiMn_{1.9}Al_{0.1}O₄ | — | — | 60 | — |
| COMP. EX. 3 | LiNi_{1/3}Mn_{1/3}Co_{1/3}O₂ | — | — | 69 | — |
| COMP. EX. 4 | LiNi_{0.80}Co_{0.15}Al_{0.05}O₂ | — | — | 63 | — |

TABLE 6

| | | | | | | ZrO₂ | | CAPACITY | |
|---|---|---|---|---|---|---|---|---|---|
| | POSITIVE | | ACTIVE | HEAT | HEAT | AVERAGE | | RATIO | AD- |
| | ELECTRODE | | MATERIAL | TREATMENT | TREATMENT | PARTICLE | | AFTER | HESIVE |
| | ACTIVE | Zr(OC₂H₅)₄ | WEIGHT | TEMPERATURE | TIME | DIAMETER | ZrO₂ | 300 | FORCE |
| | MATERIAL | (M) | (g) | (° C.) | (h) | (nm) | (wt %) | CYCLES (%) | (μN) |
| COMP. | LiNi_{1/3}Mn_{1/3}Co_{1/3}O₂ | 0.01 | 120 | 700 | 2 | 100 | 0.32 | 71 | 0.01 |
| EX. 12 | | | | | | | | | |
| COMP. | LiMn₂O₄ | 0.01 | 120 | 700 | 2 | 100 | 0.32 | 58 | 0.03 |
| EX. 13 | | | | | | | | | |
| COMP. | LiMn_{1.9}Al_{0.1}O₄ | 0.01 | 120 | 700 | 2 | 100 | 0.32 | 63 | 0.04 |
| EX. 14 | | | | | | | | | |
| COMP. | LiNi_{0.80}Co_{0.16}Al_{0.05}O₂ | 0.01 | 120 | 700 | 2 | 90 | 0.30 | 66 | 0.03 |
| EX. 15 | | | | | | | | | |

What is claimed is:

1. A method of manufacturing an active material, comprising the step of bringing a metal-fluoro complex-containing aqueous solution into contact with particles of a first metal oxide so as to form, on surfaces of the first metal oxide particles, particles of a second metal oxide that is an oxide of the metal in the metal-fluoro complex.

2. The method of manufacturing an active material according to claim 1, wherein the metal-fluoro complex is at least one selected from the group consisting of hexafluorozirconic acid and salts thereof, hexafluorosilicic acid and salts thereof, hexafluorotitanic acid and salts thereof, tin fluoride, indium fluoride, magnesium fluoride, zinc fluoride and aluminum fluoride.

3. The method of manufacturing an active material according to claim 1, wherein the metal-fluoro complex-containing aqueous solution further includes a scavenger which chemically captures fluoride ions from the metal-fluoro complex.

4. The method of manufacturing an active material according to claim 3, wherein the scavenger is boric acid or aluminum.

5. The method of manufacturing an active material according to claim 1, wherein the first metal oxide is a lithium-containing metal oxide.

6. The method of manufacturing an active material according to claim 5, wherein the first metal oxide is LiMn₂₋ₓAlₓO₄ (where 0≦x<2), LiCoₓNi_{y}Mn_{1-x-y}O₂ (where 0<x,y<1), LiNiₓCo_{y}Al_{1-x-y}O₂ (where 0<x,y<1) or Li₄Ti₅O₂.

7. The method according to claim 1, wherein the aqueous solution, when forming the particles [of the second metal oxide], has a pH of from 5 to 12.

8. The method of manufacturing an active material according to claim 1, further comprising a step of heat-treating, at from 500 to 900° C., the particles of the first metal oxide on which the particles of the second metal oxide have been formed.

9. A method of manufacturing an electrode, comprising the step of bringing a metal-fluoro complex-containing aqueous solution into contact with an electrode having an active material layer which includes particles of a first metal oxide, a conductive additive and a binder so as to form, on surfaces of the first metal oxide particles, particles of a second metal oxide that is an oxide of the metal in the metal-fluoro complex.

10. The method of manufacturing an electrode according to claim 9, wherein the metal-fluoro complex is at least one selected from the group consisting of hexafluorozirconic acid and salts thereof, hexafluorosilicic acid and salts thereof, hexafluorotitanic acid and salts thereof, tin fluoride, indium fluoride, magnesium fluoride, zinc fluoride and aluminum fluoride.

11. The method of manufacturing an electrode according to claim 9, wherein the metal-fluoro complex-containing aqueous solution further includes a scavenger which chemically captures fluoride ions from the metal-fluoro complex.

12. The method of manufacturing an electrode according to claim 11, wherein the scavenger is boric acid or aluminum.

13. The method of manufacturing an electrode according to claim 9, wherein the first metal oxide is a lithium-containing metal oxide.

14. The method of claim 13, wherein the first metal oxide is LiMn₂₋ₓAlₓO₄ (where 0≦x<2), LiCoₓNi_{y}Mn_{1-x-y}O₂ (where 0<x,y<1), LiNiₓCo_{y}Al_{1-x-y}O₂ (where 0<,y<1) or Li₄Ti₅O₁₂.

15. The method according to claim 9, wherein the aqueous solution when forming the particles of the second metal oxide has a pH of from 5 to 12.

16. An active material, comprising:
particles of a first metal oxide; and
particles of a second metal oxide, which coat the first metal oxide particle,
wherein the second metal oxide particles have an adhesive force to the first metal oxide particles of at least 0.1 μN.

17. The active material according to claim 16, wherein the second metal oxide is at least one selected from the group consisting of zirconium oxide, silicon oxide, titanium oxide, tin oxide, indium oxide, magnesium oxide, zinc oxide and aluminum oxide.

18. The active material according to claim 16, wherein the second metal oxide is tetragonal or monoclinic zirconium oxide.

19. The active material according to claim 16, wherein the first metal oxide is a lithium-containing metal oxide.

20. The active material according to claim 16, wherein the first metal oxide is LiMn₂₋ₓAlₓO₄ (where 0≦x<2), LiCoₓNi_{y}Mn_{1-x-y}O₂ (where 0<x,y<1), LiNiₓCo_{y}Al_{1-x-y}O₂ (where 0<x,y<1) or Li₄Ti₅O₁₂.

21. The active material according to claim 16, wherein the second metal oxide particles form a layer having a thickness of from 1 to 200 nm on surfaces of the first metal oxide particles.

22. The active material according to claim 16, wherein the particles of the second metal oxide have a weight ratio, based on the combined weight of the particles of the first metal oxide and the particles of the second metal oxide, of from 0.01 wt % to 1.5 wt %.

23. The active material according to claim 16, wherein the particles of the second metal oxide includes single-crystal particles.

24. An electrode comprising the active material according to claim 16.

25. An active material comprising:
particles of a first metal oxide; and
particles of a second metal oxide which coat the particles of the first metal oxide, wherein the particles of the second metal oxide contain fluorine and/or boron.

26. The active material according to claim 25, wherein the second metal oxide is at least one selected from the group consisting of zirconium oxide, silicon oxide, titanium oxide, tin oxide, indium oxide, magnesium oxide, zinc oxide and aluminum oxide.

27. The active material according to claim 25, wherein the second metal oxide is tetragonal or monoclinic zirconium oxide.

28. The active material according to claim 25, wherein the first metal oxide is a lithium-containing metal oxide.

29. The active material according to claim 25, wherein the first metal oxide is LiMn₂₋ₓAlₓO₄ (where 0≦x<2), LiCoₓNi_{y}Mn_{1-x-y}O₂ (where 0<x,y<1), LiNiₓCo_{y}Al_{1-x-y}O₂ (where 0<x,y<1) or Li₄Ti₅O₁₂.

30. The active material according to claim 25, wherein the second metal oxide particles form a layer having a thickness of from 1 to 200 nm on surfaces of the first metal oxide particles.

31. The active material according to claim 25, wherein the particles of the second metal oxide have a weight ratio, based on the combined weight of the particles of the first metal oxide and the particles of the second metal oxide, of from 0.01 wt % to 1.5 wt %.

32. The active material according to claim 25, wherein the particles of the second metal oxide includes single-crystal particles.

33. An electrode comprising the active material according to claim 25.
